(19) United States
(12) Patent Application Publication
(10) Pub. No.: US 2014/0219760 A1
(43) Pub. Date: Aug. 7, 2014

(54) REACH ASSEMBLY WITH OFFSET PIVOT POINTS FOR A MATERIALS HANDLING VEHICLE

(71) Applicants: Patrick A. Soder, Sidney, OH (US); Jay L. Kuck, St. Marys, OH (US)

(72) Inventors: Patrick A. Soder, Sidney, OH (US); Jay L. Kuck, St. Marys, OH (US)

(73) Assignee: Crown Equipment Corporation, New Bremen, OH (US)

(21) Appl. No.: 14/167,228

(22) Filed: Jan. 29, 2014

Related U.S. Application Data
(60) Provisional application No. 61/760,313, filed on Feb. 4, 2013.
(60) Provisional application No. 61/760,254, filed on Feb. 4, 2013.
(60) Provisional application No. 61/760,338, filed on Feb. 4, 2013.

(51) Int. Cl. B66F 9/12

(52) U.S. Cl. CPC B66F 9/122
USPC 414/664

(57) ABSTRACT

A materials handling vehicle includes a power unit, a mast assembly coupled to the power unit, and a reach assembly coupled for vertical movement on the mast assembly. The mast assembly includes first, second, and third weldments, wherein the first weldment is fixed to the power unit, the second weldment is movable with respect to the first weldment, and the third weldment is movable with respect to the first and second weldments. The reach assembly includes an extension/retraction mechanism for effecting horizontal movement of the reach assembly relative to the mast assembly. Components of the vehicle have been redesigned and/or rearranged to improve operator visibility.

### CROSS REFERENCE TO RELATED APPLICATIONS

This application claims the benefit of U.S. Provisional Patent Application Ser. No. 61/760,313, filed Feb. 4, 2013 and entitled “REACH ASSEMBLY WITH OFFSET PIVOT POINTS FOR A MATERIALS HANDLING VEHICLE”; U.S. Provisional Patent Application Ser. No. 61/760,254, filed Feb. 4, 2013 and entitled “MAST ASSEMBLY WITH IMPROVED OPERATOR VISIBILITY FOR A MATERIALS HANDLING VEHICLE”; and U.S. Provisional Patent Application Ser. No. 61/760,338, filed Feb. 4, 2013 and entitled “REACH ASSEMBLY WITH IMPROVED OPERATOR VISIBILITY FOR A MATERIALS HANDLING VEHICLE”, the entire disclosures of which are hereby incorporated by reference herein.

### TECHNICAL FIELD

The present invention relates to a reach assembly for use in a materials handling vehicle, wherein the horizontal reach length of the reach assembly is increased.

### BACKGROUND OF THE INVENTION

Known materials handling vehicles include a power unit, a mast assembly, and a reach assembly. The mast assembly may comprise first, second, and third weldments, wherein the second weldment is capable of moving relative to the first weldment and the third weldment is capable of moving relative to the first and second weldments. First and second lift ram/cylinder assemblies are typically coupled between the first and second weldments for effecting vertical movement of the weldments. The reach assembly may be coupled to the third weldment, and a further ram/cylinder unit may be provided for effecting movement of the reach assembly relative to the third weldment.

The reach assembly may comprise a mast carriage assembly coupled for vertical movement on the third weldment of the mast assembly and a fork carriage assembly including a pair of forks. The fork carriage assembly may be coupled to the mast carriage assembly via an extension/retraction assembly that comprises one or more pairs of pivotable extension arms that are maneuverable to allow the fork carriage assembly to move horizontally with respect to the mast carriage assembly.

### SUMMARY OF THE INVENTION

In accordance with a first aspect of the present invention, a materials handling vehicle is provided that includes a longitudinal centerline extending from a rear of the materials handling vehicle to a front of the materials handling vehicle. The vehicle comprises a power unit including an operator's compartment and a mast assembly coupled to the power unit. The mast assembly comprises first, second, and third weldments, at least one lift ram/cylinder assembly, at least one lift pulley, and at least one lift chain. The first weldment is fixed to the power unit and comprises a pair of laterally spaced apart vertical first beams that each define a first channel. The second weldment is movable with respect to the first weldment and comprises a pair of laterally spaced apart vertical second beams that each define a second channel, wherein each second beam is at least partially located within the first channel of a respective first beam. The third weldment is movable with respect to the first and second weldments and comprises a pair of laterally spaced apart vertical third beams, wherein each third beam is at least partially located within the second channel of a respective second beam. Each lift ram/cylinder assembly is positioned laterally offset with respect to the longitudinal centerline of the materials handling vehicle. Each lift pulley is fixed to the second weldment and is located between the second weldment and the operator's compartment. Each lift chain is associated with a corresponding lift pulley and has a first end affixed to one of the first weldment and a corresponding lift ram/cylinder assembly, and a second end affixed to the third weldment. The lift chain(s) and the lift pulley(s) are used in combination with the lift ram/cylinder assembly(ies) to effect movement of the second weldment relative to the first weldment.

The first weldment may comprise a laterally outermost weldment, the second weldment may be located laterally between the first and third weldments, and the third weldment may comprise a laterally innermost weldment.

The first beams of the first weldment may be the closest beams to forks of the materials handling vehicle, and the third beams of the third weldment may be the closest beams to the operator's compartment.

The at least one lift chain may comprise first and second lift chains and the at least one lift pulley may comprise first and second lift pulleys. The first and second lift chains and the first and second lift pulleys may be used in combination with the lift ram/cylinder assembly(ies) to effect movement of the third weldment relative to the first and second weldments.

The lift pulley(s) may each have an axis of rotation generally perpendicular to the longitudinal centerline of the materials handling vehicle.

The lift pulley(s) may be positioned over the respective lift ram/cylinder assembly(ies). The at least one lift ram/cylinder assembly may comprise first and second ram/cylinder assemblies, wherein the first lift ram/cylinder assembly is located to the left of the longitudinal centerline of the materials handling vehicle, and the second lift ram/cylinder assembly is located to the right of the longitudinal centerline.

The mast assembly may further comprise at least one primary ram/cylinder assembly for effecting vertical movement of a reach assembly on the third weldment, the reach assembly including a pair of forks that extend generally axially away from the power unit.

The at least one primary ram/cylinder assembly may be positioned laterally offset with respect to the longitudinal centerline of the materials handling vehicle and may be positioned axially forward from the at least one lift ram/cylinder assembly.

The second weldment may include at least one cross brace that extends laterally between the second beams and provides structural support for the second weldment, the at least one cross brace being axially spaced from the second beams of the second weldment in a direction toward the operator's compartment.

The at least one cross brace may be axially spaced from the second beams of the second weldment using counter spring housings that absorb forces when the second weldment bottoms out on the first weldment.

The third weldment may include at least one cross brace that extends laterally between the third beams and provides structural support for the third weldment.

The at least one cross brace of the third weldment may be axially spaced from the third beams of the third weldment in a direction toward the operator's compartment.

In accordance with a second aspect of the present invention, a materials handling vehicle is provided that includes a longitudinal centerline extending from a rear of the materials handling vehicle to a front of the materials handling vehicle. The vehicle comprises a power unit including an operator's compartment and a mast assembly coupled to the power unit. The mast assembly comprises first, second, and third weldments. The first weldment is fixed to the power unit and comprises a pair of laterally spaced apart vertical first beams, each first beam defining a first channel and including axially spaced apart forward and rear lateral first bars that at least partially define the respective first channels. The second weldment is movable with respect to the first weldment and comprises a pair of laterally spaced apart vertical second beams that each define a second channel, each second beam being at least partially located within the first channel of a respective first beam and each second beam including axially spaced apart forward and rear lateral second bars that at least partially define the respective second channels. The third weldment is movable with respect to the first and second weldments and comprises a pair of laterally spaced apart vertical third beams, each third beam being at least partially located within the second channel of a respective second beam and each third beam including axially spaced apart forward and rear lateral third bars. The forward first bars of the first weldment are the closest bars of the mast assembly to forks of the materials handling vehicle. The rear second bars of the second weldment are closer to the operator's compartment than the rear first bars of the first weldment. The rear third bars are the closest bars of the mast assembly to the operator's compartment such that the mast assembly comprises a reverse stack arrangement.

The materials handling vehicle may further comprise at least one lift ram/cylinder assembly coupled to the second weldment to effect movement of the second weldment relative to the first weldment and to effect movement of the third weldment relative to the first and second weldments.

The at least one lift ram/cylinder assembly may comprise first and second lift ram/cylinder assemblies and the materials handling vehicle may further comprise first and second lift pulleys fixed to the second weldment and being located between the rear second bars of the second weldment and the operator's compartment. The materials handling vehicle may additionally comprise first and second lift chains associated with the respective first and second lift pulleys, the first and second lift chains each having a first end affixed to one of the first weldment and a respective lift ram/cylinder assembly, and a second end affixed to the third weldment. The first and second lift chains and the first and second lift pulleys are used in combination with the first and second lift ram/cylinder assemblies to effect movement of the second weldment relative to the first weldment and to effect movement of the third weldment relative to the first and second weldments.

In accordance with a third aspect of the present invention, a reach assembly is provided for use on a materials handling vehicle. The reach assembly comprises a mast carriage assembly coupled for vertical movement on a mast assembly of the materials handling vehicle, a fork carriage assembly comprising a pair of forks, and an extension/retraction mechanism for effecting horizontal movement of the fork carriage assembly relative to the mast carriage assembly. The extension/retraction mechanism comprises at least one first arm having a first end pivotably coupled to the mast carriage assembly and a second end slidably coupled to the fork carriage assembly, and at least one second arm having a first end slidably coupled to the mast carriage assembly and a second end pivotably coupled to the fork carriage assembly. The at least one second arm is pivotably coupled to the at least one first arm at a pivot point that is located: closer to the first end of the at least one first arm than to the second end of the at least one first arm; closer to the second end of the at least one first arm than to the first end of the at least one first arm; closer to the first end of the at least one second arm than to the second end of the at least one second arm; and/or closer to the second end of the at least one second arm than to the first end of the at least one second arm.

The pivot point may be offset with respect to an axis that extends between locations where the ends of the second arm are respectively coupled to the mast carriage assembly and the fork carriage assembly.

The second end of the first arm may be slidably received in a curved roller track of the fork carriage assembly such that when the extension/retraction mechanism is extended and retracted the forks of the fork carriage assembly remain substantially level. The curved roller track of the fork carriage assembly may comprise a concave side that faces away from the forks of the fork carriage assembly.

The first end of the second arm may be slidably received in a generally vertical roller track of the mast carriage assembly.

The at least one first arm may comprise a pair of first laterally spaced apart arms, and the at least one second arm may comprise a pair of laterally spaced apart second arms. The first arms may be positioned laterally inwardly from the respective second arms, and the first arms may be structurally coupled together.

The second end of the second arm may be located closer to an operator's compartment of the materials handling vehicle than the first end of the first arm when the extension/retraction mechanism is positioned in a fully retracted position, wherein the operator's compartment is located on an opposite side of the materials handling vehicle than the forks. The second end of the second arm may be located further from the operator's compartment than the first end of the first arm when the extension/retraction mechanism is positioned in an extended position.

In accordance with a fourth aspect of the present invention, a reach assembly is provided for use on a materials handling vehicle. The reach assembly comprises a mast carriage assembly coupled for vertical movement on a mast assembly of the materials handling vehicle, a fork carriage assembly comprising a pair of forks, and an extension/retraction mechanism for effecting horizontal movement of the fork carriage assembly relative to the mast carriage assembly. The extension/retraction mechanism comprises a pair of laterally spaced apart inner arms having a first ends pivotably coupled to the mast carriage assembly and second ends slidably coupled to the fork carriage assembly, and a pair of laterally spaced apart outer arms positioned laterally outwardly from the inner arms and having first ends slidably coupled to the mast carriage assembly and second ends pivotably coupled to the fork carriage assembly. The inner arms are pivotably coupled to the outer arms at respective pivot points that are located: closer to one of the first and second ends of the respective inner arms than to the other of the first and second ends of the inner arms and closer to one of the first and second ends of the respective outer arms than to the other of the first and second ends of the outer arms.

The respective pivot points may be offset with respect to axes that extend between locations where the ends of the respective outer arms are respectively coupled to the mast carriage assembly and the fork carriage assembly.

The second ends of the inner arms may be slidably received in respective curved roller tracks of the fork carriage assembly such that when the extension/retraction mechanism is extended and retracted the forks of the fork carriage assembly remain substantially level. The curved roller tracks of the fork carriage assembly may each comprise a concave side that faces away from the forks of the fork carriage assembly.

The first ends of the outer arms may be slidably received in generally vertical roller tracks of the mast carriage assembly.

The second ends of the outer arms may be located closer to an operator's compartment of the materials handling vehicle than the first ends of the inner arms when the extension/retraction mechanism is positioned in a fully retracted position, wherein the operator's compartment is located on an opposite side of the materials handling vehicle than the forks. The second ends of the outer arms may be located further from the operator's compartment than the first ends of the inner arms when the extension/retraction mechanism is positioned in an extended position.

In accordance with a fifth aspect of the present invention, a reach assembly is provided for use on a materials handling vehicle. The reach assembly comprises a mast carriage assembly coupled for vertical movement on a mast assembly of the materials handling vehicle, a fork carriage assembly comprising a pair of forks, and an extension/retraction mechanism for effecting horizontal movement of the fork carriage assembly relative to the mast carriage assembly. The extension/retraction mechanism comprises a pair of rear first arms having first ends pivotably coupled to the mast carriage assembly and second ends, a pair of front first arms having first ends pivotably coupled to the rear first arms and second ends slidably coupled to the fork carriage assembly, a pair of rear second arms having first ends slidably coupled to the mast carriage assembly and second ends, and a pair of front second arms having first ends pivotably coupled to the rear second arms and second ends pivotably coupled to the fork carriage assembly. At least one of: the rear first arms are pivotably coupled to the rear second arms at respective pivot points that are located closer to one of the first and second ends of the respective rear first arms than to the other of the first and second ends of the rear first arms and/or closer to one of the first and second ends of the respective rear second arms than to the other of the first and second ends of the rear second arms; and the front first arms are pivotably coupled to the front second arms at respective pivot points that are located closer to one of the first and second ends of the respective front first arms than to the other of the first and second ends of the front first arms and/or closer to one of the first and second ends of the respective front second arms than to the other of the first and second ends of the front second arms.

The rear first arms may comprise rear inner arms, the front first arms may comprise front inner arms, the rear second arms may comprise rear outer arms, and the front second arms may comprise front outer arms.

The second ends of the front inner arms may be slidably received in respective curved roller tracks of the fork carriage assembly, such that when the extension/retraction mechanism is extended and refracted the forks of the fork carriage assembly remain substantially level.

The second ends of the rear outer arms may be located closer to an operator's compartment of the materials handling vehicle than the first ends of the rear inner arms when the extension/retraction mechanism is positioned in a fully retracted position, wherein the operator's compartment is located on an opposite side of the materials handling vehicle than the forks. The second ends of the rear outer arms may be located further from the operator's compartment than the first ends of the rear inner arms when the extension/retraction mechanism is positioned in an extended position.

In accordance with a sixth aspect of the present invention, a reach assembly is provided for use on a materials handling vehicle including an operator's compartment. The reach assembly comprises a mast carriage assembly coupled for vertical movement on a mast assembly of the materials handling vehicle, a fork carriage assembly comprising a pair of forks, and an extension/retraction mechanism for effecting longitudinal movement of the fork carriage assembly relative to the mast carriage assembly. The extension/retraction mechanism comprises a pair of spaced apart inner arms coupled between the mast carriage assembly and the fork carriage assembly, and a pair of spaced apart outer arms laterally outward from the respective inner arms and coupled between the mast carriage assembly and the fork carriage assembly. The outer arms are pivotably coupled to the inner arms to enable the longitudinal movement of the fork carriage assembly relative to the mast carriage assembly. The extension/retraction mechanism further comprises an upper coupling member extending laterally between the inner arms, an intermediate coupling member positioned beneath the upper coupling member and extending laterally between the inner arms, a lower coupling member positioned beneath the intermediate coupling member and extending laterally between the inner arms, the coupling members providing structural rigidity for the extension/retraction mechanism, and first and second operator viewing windows extending longitudinally through the reach assembly when the extension/retraction mechanism is in a retracted position. The first operator viewing window is defined between the upper and intermediate coupling members. The second operator viewing window is vertically spaced apart from the first operator viewing window and is defined between the intermediate and lower coupling members. The operator viewing windows have vertical dimensions that are larger than a vertical height of at least one of the coupling members.

The operator viewing windows may have vertical dimensions that are larger than each of the coupling members.

The fork carriage assembly may further comprise a tilt and side shift bar used for tilt and side shift functions. The tilt and side shift bar may be generally vertically in plane with the intermediate coupling member when the extension/retraction mechanism is in a fully retracted position.

The fork carriage assembly may further comprise a frame, comprising a hanger bar from which the forks extend and a lower member. The tilt and side shift bar, the hanger bar of the frame, and the intermediate coupling member may each intersect a common horizontal plane so as to be longitudinally stacked with one another when the extension/retraction mechanism is in a fully retracted position.

The lower member of the frame and the lower coupling member may each intersect a common horizontal plane so as to be longitudinally stacked with one another when the extension/retraction mechanism is in a fully retracted position.

The fork carriage assembly may further comprise an upper cross brace that is located between the upper and intermediate coupling members when the extension/retraction mechanism is in a fully retracted position, the upper cross brace dividing the first operator viewing window into upper and lower first operator viewing window portions.

The first operator viewing window portions may have vertical dimensions that are larger than at least one of the coupling members.

The reach assembly may further comprise a piston cylinder assembly for extending and retracting the extension/retraction mechanism to effect longitudinal movement of the fork carriage assembly relative to the mast carriage assembly.

The piston cylinder assembly may comprise a single cylinder that is laterally offset with respect to a longitudinal centerline of the materials handling vehicle so as to allow improved visibility through the first and second operator viewing windows.

In accordance with a seventh aspect of the present invention, a reach assembly is provided for use on a materials handling vehicle including an operator's compartment. The reach assembly comprises a mast carriage assembly coupled for vertical movement on a mast assembly of the materials handling vehicle, a fork carriage assembly comprising a frame that supports a pair of forks, a tilting mechanism for effecting tilting movement of the frame relative to the mast carriage assembly, and a pair of tilt limiters that limit the amount of tilting movement that the frame can undergo relative to the mast carriage assembly. The tilt limiters are spaced apart from one another in a lateral direction and are laterally offset with respect to a longitudinal centerline of the materials handling vehicle so as to allow improved visibility from the operator's compartment through an operator viewing space defined between the tilt limiters.

The tilt limiters may each have a lower abutment surface for contacting an upper surface of a lower member of the frame as the frame is being tilted to define an uppermost tilt position for the frame.

The tilt limiters may be affixed to vertical members of the fork carriage assembly and may extend from the vertical members in a longitudinal direction toward the forks.

A lateral distance of the operator viewing space between the tilt limiters may be at least about 150 mm, and a lateral distance of the operator viewing space between the tilt limiters may be at least about 5 times a lateral width of each of the tilt limiters.

In accordance with an eighth aspect of the present invention, a reach assembly is provided for use on a materials handling vehicle including an operator's compartment. The reach assembly comprises a mast carriage assembly coupled for vertical movement on a mast assembly of the materials handling vehicle, and a fork carriage assembly comprising a pair of forks and being moveable longitudinally with respect to the mast carriage assembly. The mast carriage assembly includes a rear box weldment comprising an upper support plate, a lower support plate vertically spaced from the upper support plate, and a pair of side plates extending from the upper support plate to the lower support plate. The side plates each comprise an intermediate member having first and second side faces that face in a lateral direction of the materials handling vehicle, a rear member extending laterally inwardly from a rear end of the intermediate member, located proximal to the operator's compartment, and having first and second side faces that face in a longitudinal direction of the materials handling vehicle, and a front member extending laterally outwardly from a front end of the intermediate member, located distal to the operator's compartment, and having first and second side faces that face in the longitudinal direction of the materials handling vehicle. The front, intermediate, and rear members of the side plates provide each of the side plates with a cross section having a Z-shape when viewed from above.

A front portion of an upper surface of the upper support plate of the rear box weldment may be chamfered.

The intermediate member of each of the first and second side plates may have a larger longitudinal dimension than a lateral dimension of the front and rear members of each of the first and second side plates.

### BRIEF DESCRIPTION OF THE DRAWINGS

While the specification concludes with claims particularly pointing out and distinctly claiming the present invention, it is believed that the present invention will be better understood from the following description in conjunction with the accompanying Drawing Figures, in which like reference numerals identify like elements, and wherein:

FIG. 1 is a perspective view of a fork lift truck including a mast assembly and a reach assembly constructed in accordance with embodiments of the present invention;

FIG. 2 is a perspective view of a lower portion of the fork lift truck illustrated in FIG. 1;

FIG. 3 is a top view of the fork lift truck illustrated in FIG. 1;

FIG. 4 is an exploded view of the mast assembly and also showing the reach assembly of the fork lift truck of FIG. 1;

FIG. 5A is a front perspective view of the mast assembly illustrated in FIG. 1 with the reach assembly removed;

FIG. 5B is a rear perspective view of the mast assembly and the reach assembly of FIG. 1;

FIG. 6 is a rear perspective view of a middle weldment of the mast assembly of FIG. 1;

FIG. 7 is a rear perspective view of an inner weldment of the mast assembly of FIG. 1;

FIG. 8 is a cross sectional view of the mast assembly taken along line 8-8 in FIG. 1, with the reach assembly removed for clarity;

FIG. 9 is a perspective view showing a lower portion of the mast assembly of FIG. 1, with the reach assembly removed;

FIGS. 10 and 11 are perspective views illustrating the reach assembly of FIG. 1 in respective fully retracted (FIG. 10) and fully extended (FIG. 11) positions, wherein the mast assembly has been removed for clarity;

FIG. 11A is a partial cross sectional view through line 11A in FIG. 11;

FIG. 12 is an exploded perspective view of the reach assembly of FIG. 1;

FIGS. 13-15 are schematic diagrams illustrating an extension/retraction mechanism of the reach assembly of FIG. 1;

FIG. 13A is an enlarged view of a portion of FIG. 13;

FIG. 16 is a side cross sectional view of the reach assembly of FIG. 1;

FIG. 17 is a rear view of the reach assembly of FIG. 1;

FIG. 18 is a front perspective view of a portion of the reach assembly of FIG. 1;

FIG. 19 is a front perspective view of the reach assembly of FIG. 1 shown in a fully lowered position on the mast assembly of the fork lift truck; and

FIG. 20 is a schematic diagram of a reach assembly in accordance with another aspect of the present invention.

### DETAILED DESCRIPTION OF THE INVENTION

In the following detailed description of the preferred embodiments, reference is made to the accompanying drawings that form a part hereof, and in which is shown by way of illustration, and not by way of limitation, specific preferred embodiments in which the invention may be practiced. It is to be understood that other embodiments may be utilized and that changes may be made without departing from the spirit and scope of the present invention.

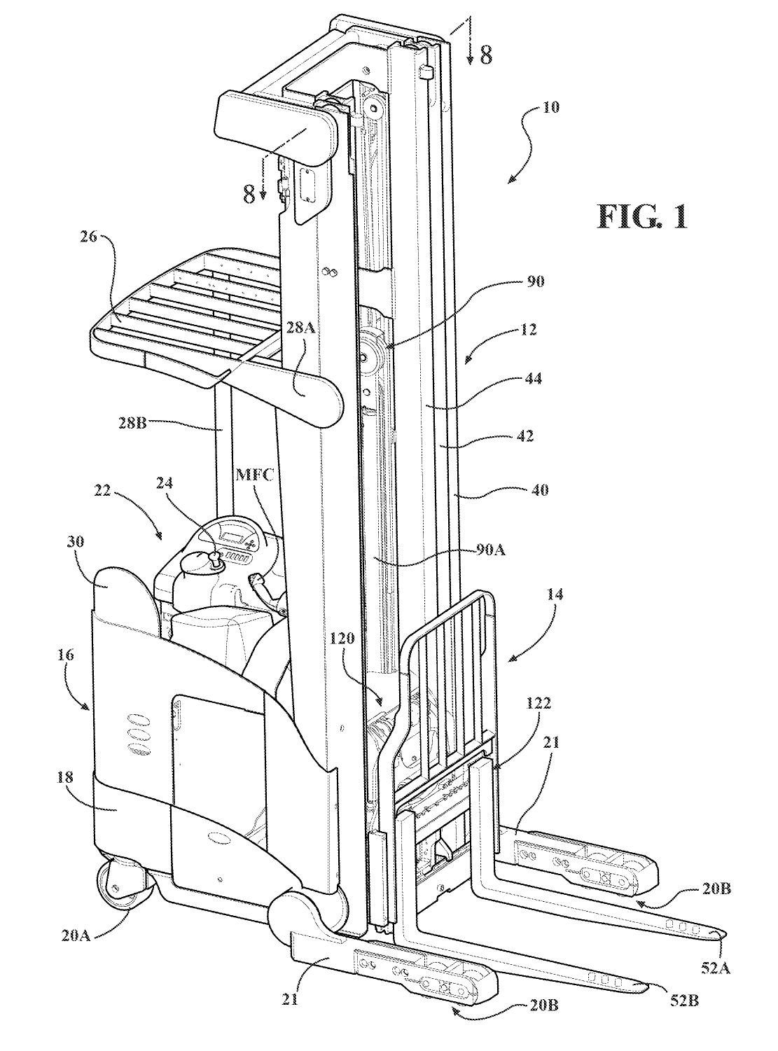

Reference is now made to FIGS. 1-3, which illustrate a materials handling vehicle, and, more particularly, a reach fork lift truck 10. The truck 10 includes a mast assembly 12 and a reach assembly 14, each of which will be described in detail herein. While the present invention is described herein with reference to the reach truck 10, it will be apparent to those skilled in the art that the mast assembly 12 and the reach assembly 14, and variations thereof, can be more generally applied to a variety of other materials handling vehicles, such as a stand-up counterbalanced fork lift truck.

The fork lift truck 10 further includes a main body or power unit 16, which includes a frame 18, first and second rear wheels 20A, at least one of which is a driven or powered wheel and at least one of which is a steered wheel, and first and second front wheel assemblies 20B coupled to first and second straddle legs 21. The rear wheels 20A and the front wheel assemblies 20B allow the truck 10 to move across a floor surface.

An operator's compartment 22 is located within the main body frame 18 for receiving an operator. The speed and direction of movement (forward or reverse) of the truck 10 are controlled by the operator via a multifunction controller MFC, and steering is controlled via a steering tiller 24.

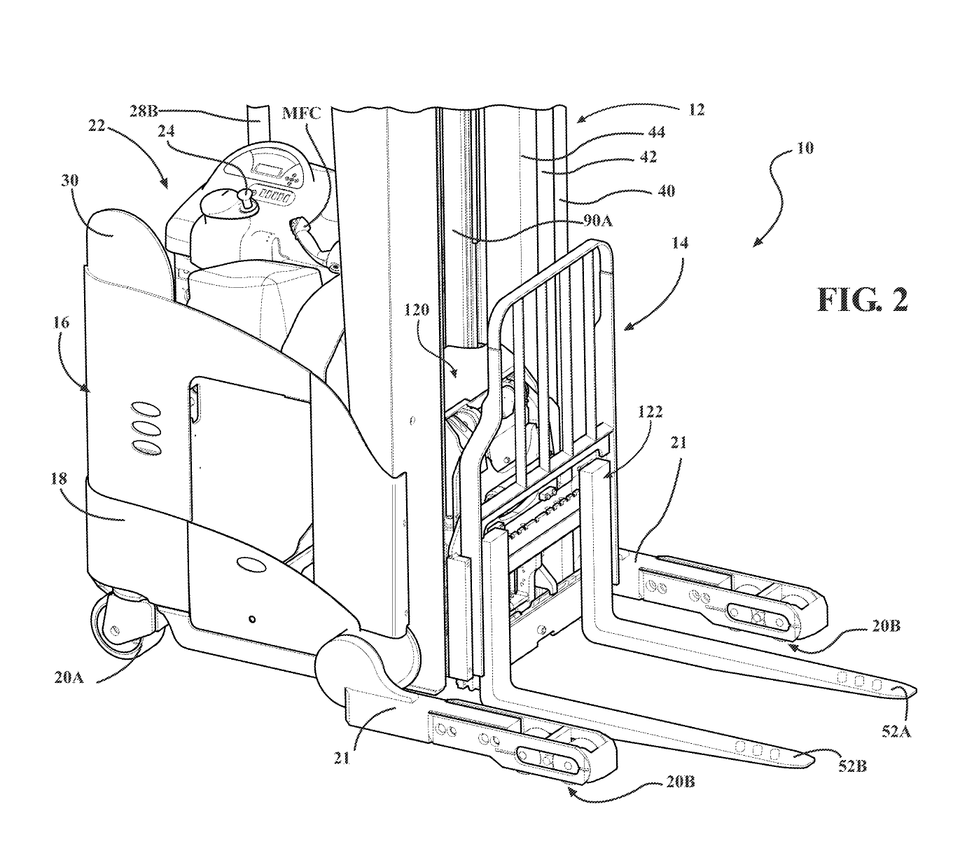

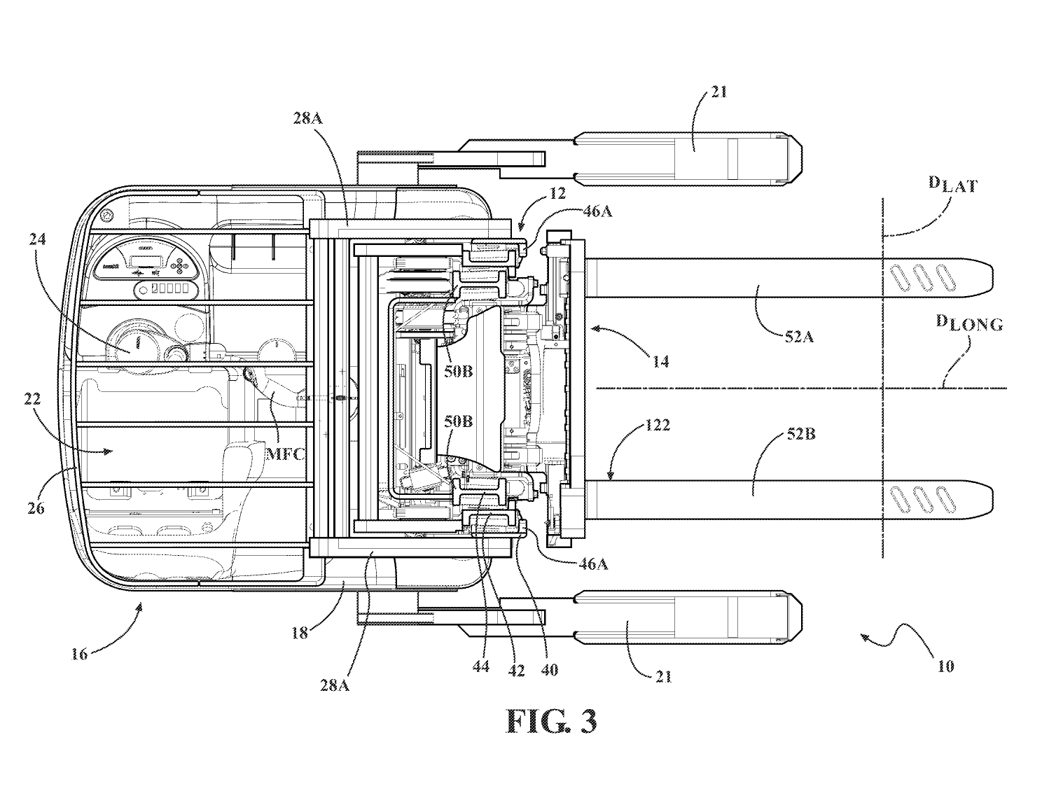

The truck 10 further includes an overhead guard 26 coupled to the frame 18 by first and second horizontal support members 28A affixed to the mast assembly 12 (see FIGS. 1 and 3) and a vertical support pillar 28B affixed to the frame 18 (see FIGS. 1 and 2). An operator backrest 30 is provided in the operator's compartment 22 at the rear corner of the frame 18, see FIGS. 1 and 2.

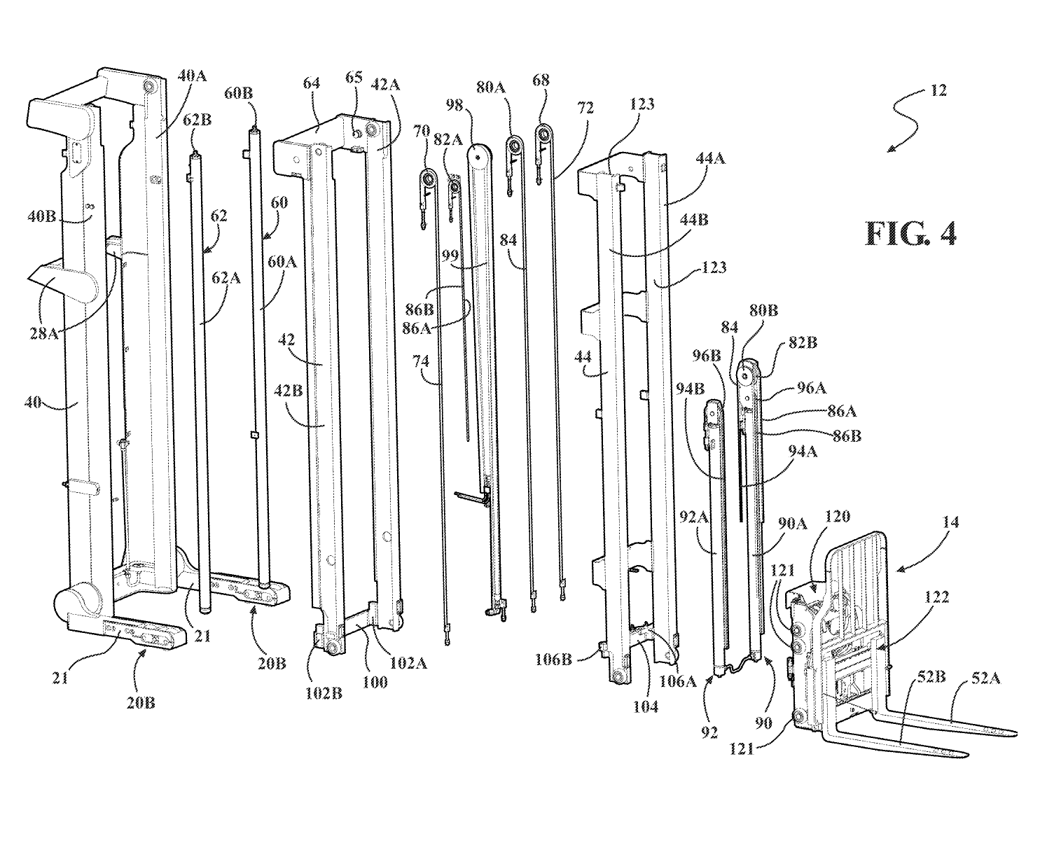

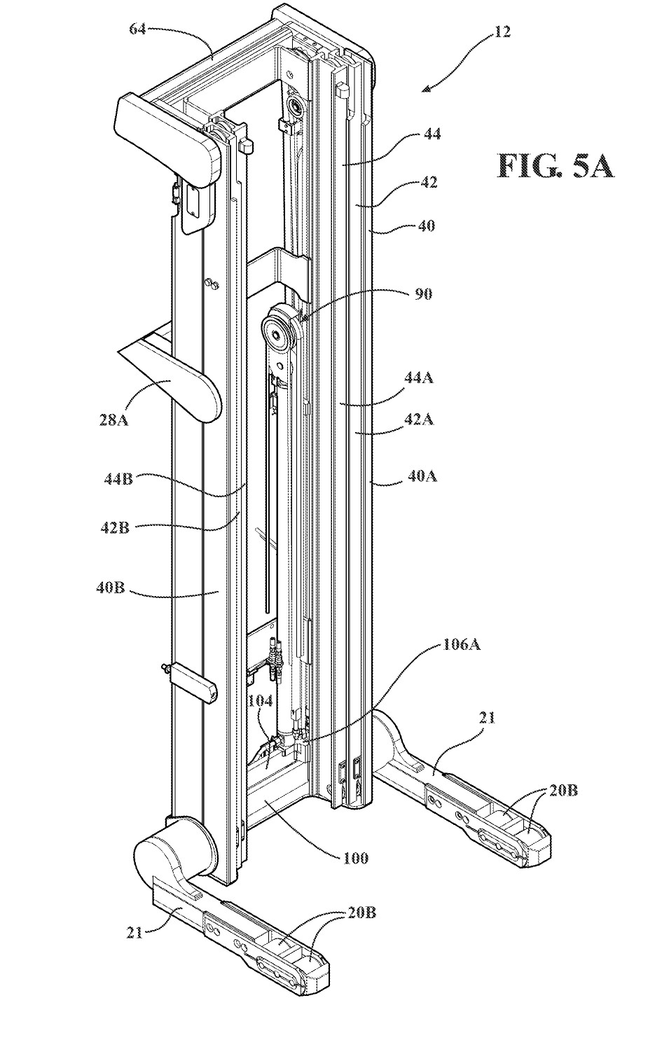

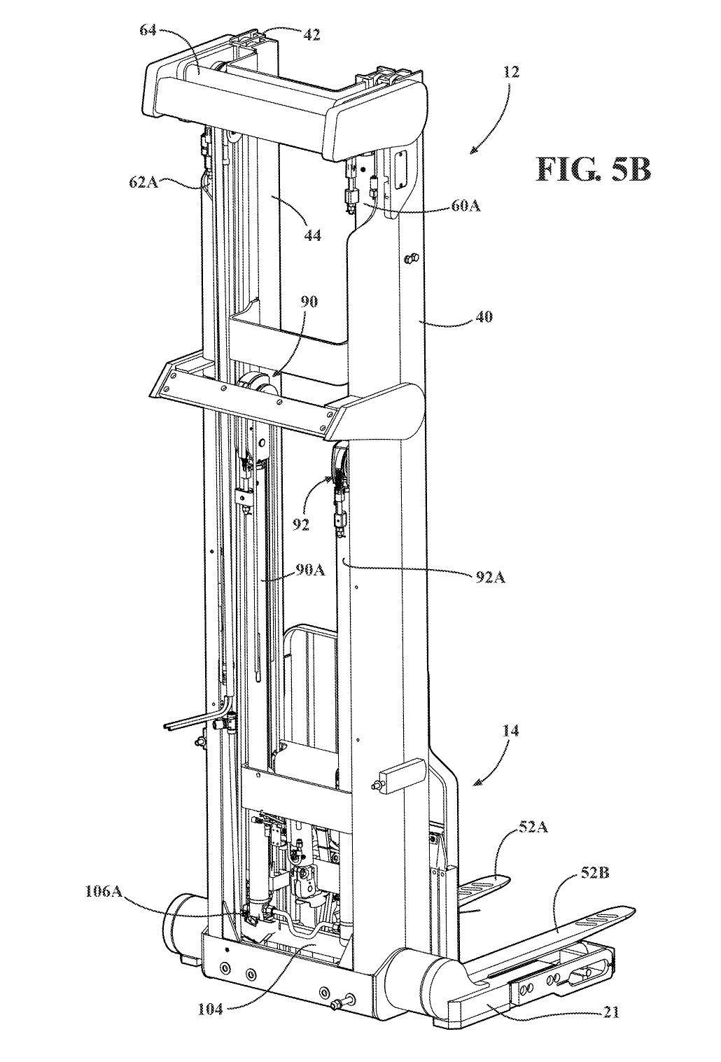

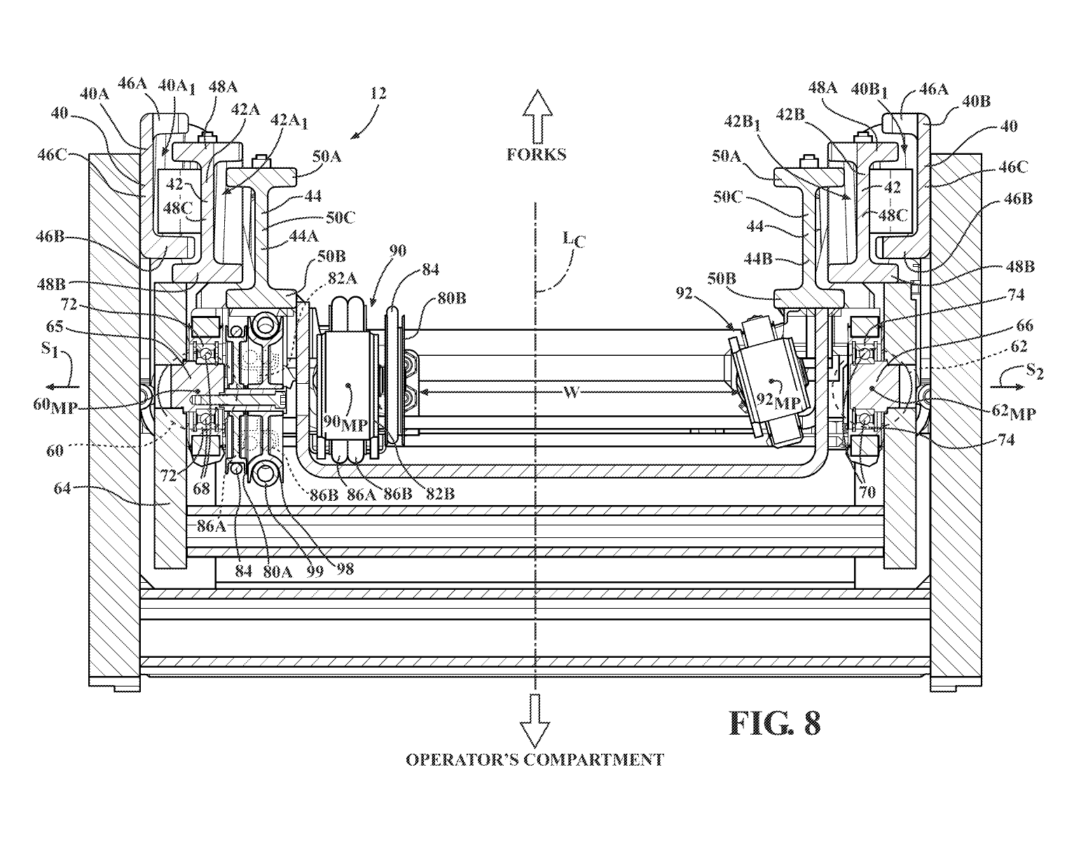

Referring additionally to FIGS. 4-8, the mast assembly 12 includes first, second and third weldments 40, 42, 44, also referred to herein as outer, middle, and inner weldments, respectively. As shown most clearly in FIG. 8, the first weldment 40 comprises a pair of laterally spaced apart vertical first beams 40A, 40B comprising outer C-shaped beams that define C-channels 40A₁, 40B₁. The vertical first beams 40A, 40B are rigidly fixed to the main body frame 18 such that the first weldment 40 does not move relative to the frame 18.

The second weldment 42 comprises a pair of laterally spaced apart vertical second beams 42A, 42B comprising intermediate I-beams that define channels 42A₁, 42B₁. The vertical second beams 42A, 42B are at least partially located within and are vertically moveable within the respective channels 40A₁, 40B₁ of the first weldment 40, i.e., the second weldment 42 is capable of vertical movement relative to the first weldment 40.

The third weldment 44 comprises a pair of laterally spaced apart vertical third beams 44A, 44B comprising inner I-beams that are at least partially located within and are vertically moveable within the respective channels of the 42A₁, 42B₁ of the intermediate I-beams 42A, 42B of the second weldment 42, i.e., the third weldment 44 is capable of vertical movement relative to the first and second weldments 40, 42.

Referring still to FIG. 8, the vertical first beams 40A, 40B of the first weldment 40 each include axially spaced apart forward and rear lateral first bars 46A and 46B and a first spanning bar 46C that collectively define the respective C-channels 40A₁, 40B₁. The vertical second beams 42A, 42B of the second weldment 42 each include axially spaced apart forward and rear lateral second bars 48A and 48B and a second spanning bar 48C that collectively define the respective channels 42A₁, 42B₁. The vertical third beams 44A, 44B of the third weldment 44 each include axially spaced apart forward and rear lateral third bars 50A and 50B and a third spanning bar 50C.

As can be seen most clearly in FIG. 8, the forward first bars 46A of the first weldment 40 are the closest bars 46A-50C of the mast assembly 12 to forks 52A, 52B of the truck 10. The rear second bars 48B of the second weldment 42 are closer to the operator's compartment 22 than the rear first bars 46B of the first weldment 40. The rear third bars 50B are the closest bars 46A-50C of the mast assembly 12 to the operator's compartment 22.

The arrangement of the first, second, and third weldments 40, 42, 44 as shown in FIGS. 1-8 defines a reverse stack arrangement, wherein the first weldment 40 is the laterally outermost weldment and is also the axially outermost weldment, i.e., the first weldment 40 is nearest to forks 52A, 52B (see FIGS. 1-4) of the reach assembly 14, the second weldment 42 is located laterally and axially between the first and third weldments 40, 44, and the third weldment 44 is the laterally innermost weldment and is also the axially innermost weldment, i.e., the third weldment 44 is nearest to the operator's compartment 22, see FIG. 8. It is believed that this reverse stack arrangement provides improved operator visibility through an opening/window W (see FIG. 8) of the mast assembly 12 and also to left and right sides S₁, S₂ of the mast assembly 12 (See FIG. 8).

Referring to FIGS. 4 and 8, the mast assembly 12 further comprises first and second weldment lift ram/cylinder assemblies 60, 62, also referred to herein as secondary lift ram/cylinder assemblies, that are provided for effecting movement of the second and third weldments 42, 44 relative to the first weldment 40. Bottom portions of cylinders 60A, 62A of the secondary lift ram/cylinder assemblies 60, 62 in the illustrated embodiment are coupled to the first weldment 40, but they could also be coupled to the frame 18. Upper portions of rams 60B, 62B that are housed within the cylinders 60A, 62A and extend from the cylinders 60A, 62A under the control of pressurized hydraulic fluid are fixed to an upper brace 64 of the second weldment 42, see FIGS. 4, 6, and 8.

The first secondary lift ram/cylinder assembly 60 is located far to the left of a longitudinal centerline L_{C} of the truck 10 and the second secondary lift ram/cylinder assembly 62 is located far to the right of the longitudinal centerline L_{C}, see FIG. 8. In the embodiment shown, the first and second secondary lift ram/cylinder assemblies 60, 62 are positioned underneath respective first and second pulley-mounting structures 65, 66 (see FIG. 8), which will be discussed below. The first and second secondary lift ram/cylinder assemblies 60, 62 are generally laterally aligned with the vertical second beams 42A, 42B of the second weldment 42, i.e., the first and second secondary lift ram/cylinder assemblies 60, 62 are generally the same distance from the longitudinal centerline L_{C} as the vertical second beams 42A, 42B of the second weldment 42 are from the longitudinal centerline L_{C}. The positioning of the first and second secondary lift ram/cylinder assemblies 60, 62 in the illustrated embodiment is believed to further improve operator visibility through the opening/window W of the mast assembly 12, as opposed to an arrangement where the first and second secondary lift ram/cylinder assemblies 60, 62 are located on or near the longitudinal centerline L_{C} of the truck 10, as is the case with many prior art lift trucks.

The mast assembly 12 further comprises first and second lift pulleys 68, 70 that are mounted to the pulley-mounting structures 65, 66, see FIGS. 4 and 8. The pulley-mounting structures 65, 66 extend laterally inwardly from the cross brace 64 at the top of the second weldment 42. As shown in FIG. 8, the lift pulleys 68, 70 are located completely behind the first, second, and third weldments 40, 42, 44 and are positioned generally laterally in line with the rear second bars 48B of the second weldment 42. The lift pulleys 68, 70 are further positioned generally directly over the first and second secondary lift ram/cylinder assemblies 60, 62 and have axes of rotation that are generally perpendicular to the longitudinal centerline L_{C} of the truck 10.

Referring to FIG. 4, first and second lift chains 72, 74 extend about the respective lift pulleys 68, 70. First ends of the chains 72, 74 are affixed to the bottom portions of the cylinders 60A, 62A of the secondary lift ram/cylinder assemblies 60, 62, although it is noted that the first ends of the chains 72, 74 could be affixed to lower end portions of the vertical first beams 40A, 40B of the first weldment 40, to other structure affixed to the frame 12, or the frame 12 itself. Second ends of the chains 72, 74 are affixed to lower end portions of the vertical third beams 44A, 44B of the third weldment 44.

The chains 72, 74 and the lift pulleys 68, 70 are used in combination with the secondary lift ram/cylinder assemblies 60, 62 to effect movement of the second and third weldments 42, 44. Specifically, when the rams 60B, 62B of the secondary lift ram/cylinder assemblies 60, 62 are extended, the rams 60B, 62B lift the second weldment 42 vertically relative to the first weldment 40, which is fixed to the frame 18 as discussed above. This movement causes the first and second lift pulleys 68, 70, which are fixed to the cross brace 64 at the top of the second weldment 42, to apply upward forces on the chains 72, 74, causing the third weldment 44 to move vertically relative to the first and second weldments 40, 42. For every one unit of vertical movement of the second weldment 42 relative to the first weldment 40, the third weldment 44 moves vertically two units relative to the first weldment 40 and one unit relative to the second weldment 42.

The truck 10 further comprises first and second electric cable pulleys 80A, 80B and first and second hydraulic fluid line pulleys 82A, 82B, see FIGS. 4 and 8. The first electric cable pulley 80A is secured to the first pulley-mounting structure 65 and the first hydraulic fluid line pulley 82A is secured to the second weldment 42 underneath the first electric cable pulley 80A, see FIG. 8. The second electric cable pulley 80B and the second hydraulic fluid line pulley 82B are both secured to the top of a first primary ram/cylinder assembly 90, which will be discussed below, see FIGS. 4 and 8. An electric cable 84 that provides electric current to the reach assembly 14 extends about both of the electric cable pulleys 80A, 80B, and hydraulic fluid supply and return lines 86A, 86B that deliver and return hydraulic fluid to/from the reach assembly 14 extend about both the hydraulic fluid line pulleys 82A, 82B.

The truck 10 further comprises first and second primary ram/cylinder assemblies 90, 92, see FIGS. 4 and 8. The primary ram/cylinder assemblies 90, 92 are coupled between the third stage weldment 44 and the reach assembly 14 to effect vertical movement of the reach assembly 14 relative to the third stage weldment 44. Specifically, bottom portions of cylinders 90A, 92A of the primary lift ram/cylinder assemblies 90, 92 are coupled to the third weldment 44, as will be discussed below, and carriage lift chains 94A, 94B that extend around pulleys 96A, 96B at the top of the respective primary lift ram/cylinder assemblies 90, 92 are fastened at first ends thereof to the bottom portions of cylinders 90A, 92A and at second ends thereof to the reach assembly 14.

As shown in FIG. 8, the primary ram/cylinder assemblies 90, 92 are positioned laterally offset with respect to the longitudinal centerline L_{C} of the truck 10 and are positioned slightly axially forward from the lift ram/cylinder assemblies 60, 62, i.e., longitudinal midpoints 90_{MP}, 92_{MP} of the primary ram/cylinder assemblies 90, 92 are positioned slightly axially forward from longitudinal midpoints 60_{MP}, 62_{MP} of the lift ram/cylinder assemblies 60, 62.

The truck 10 additionally comprises a primary cylinder hydraulic fluid line pulley 98 (see FIGS. 4 and 8) that is secured to the first pulley-mounting structure 65, see FIG. 8. A hydraulic fluid line 99 that provides hydraulic fluid to the primary ram/cylinder assemblies 90, 92 extends about the primary cylinder hydraulic fluid line pulley 98. It is noted that gravity is used during reach assembly lowering procedures, wherein hydraulic fluid is permitted to flow back through the hydraulic fluid line 99 when the primary ram/cylinder assemblies 90, 92 are being lowered, such that a separate hydraulic fluid return line is not required for the primary ram/cylinder assemblies 90, 92.

As shown in FIG. 8, the pulleys 68, 70, 80, 82, 98, the lift chains 72, 74, the electric cables 84, 99, the hydraulic fluid lines 86A, 86B, 99, and the primary ram/cylinder assemblies 90, 92 are positioned to the sides of the operator viewing window W, thus maximizing the dimensions of the operator viewing window W so as to improve operator visibility through the mast assembly 12. Further, the second primary ram/cylinder assembly 92 is disposed at an angle so as to further improve operator visibility through the mast assembly 12, see FIG. 8. For example, by angling the second primary ram/cylinder assembly 92, the pulley 96B is oriented at an angle such that sides thereof extend generally parallel to an operator's line of sight through the operator viewing window W, thus increasing operator visibility. Further, angling the second primary ram/cylinder assembly 92 effects an increase in the width of the operator viewing window W, i.e., since the second primary ram/cylinder assembly 92 is located farther laterally from the longitudinal centerline L_{C} of the truck 10.

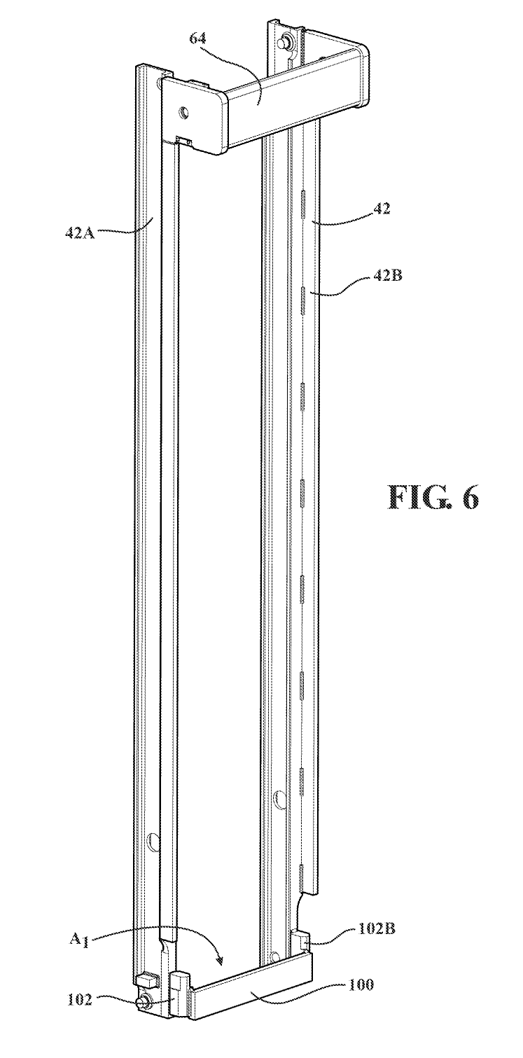

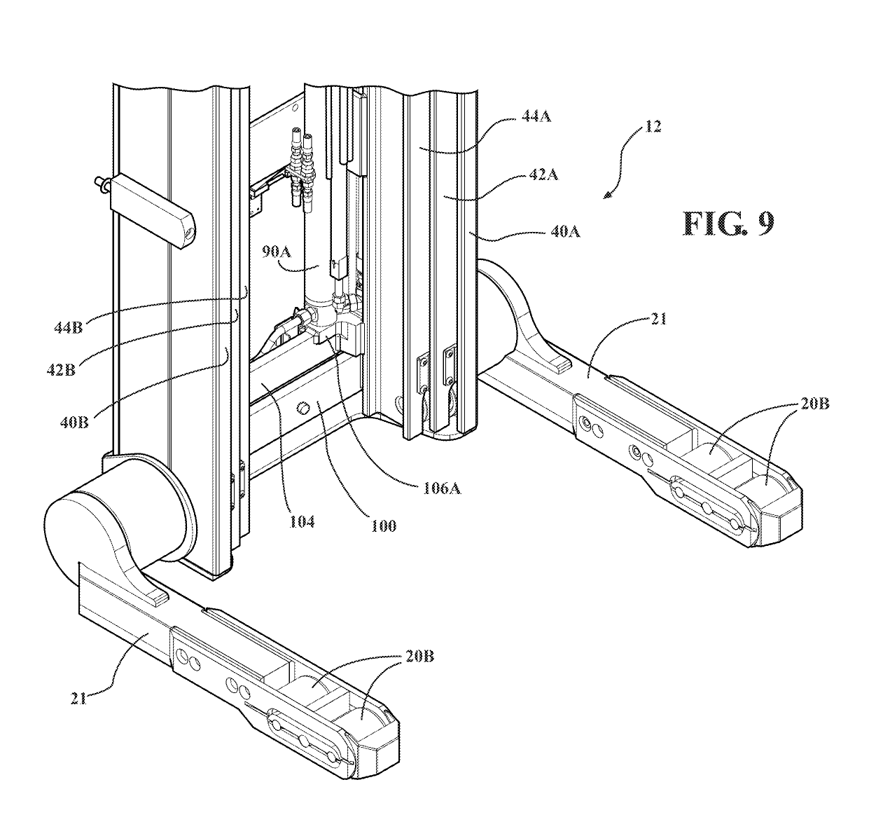

Referring now to FIGS. 4-7 and 9, the specific configuration of the mast assembly 12 allows the third weldment 44 to be raised and then lowered onto an unattached reach assembly 14 to facilitate ease of attachment of the reach assembly 14 on the truck 10. Specifically, referring to FIGS. 4, 5A, 6, and 9, a lower cross brace 100 extends laterally between the vertical beams 42A, 42B of the second weldment 42 so as to provide structural support for the second weldment 42. The lower cross brace 100 is spaced axially from the vertical beams 42A, 42B of the second weldment 42 in a direction toward the operator's compartment 22 via first and second counter-spring housings 102A, 102B to define a first open area A₁ behind the lower cross brace 100, see FIG. 6. In addition to functioning as spacers to create the first open area A₁ behind the lower cross brace 100, the first and second counter-spring housings 102A, 102B absorb forces when the second weldment 42 bottoms out on the first weldment 40, i.e., during a weldment lowering operation.

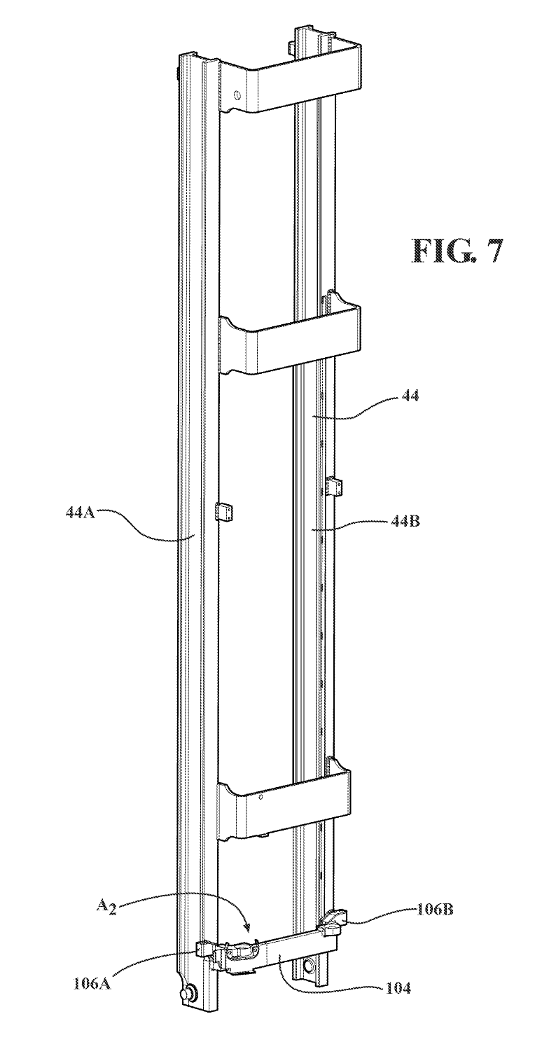

Referring to FIGS. 4, 5A, 5B, 7, and 9, a lower cross brace 104 extends laterally between the vertical beams 44A, 44B of the third weldment 44 so as to provide structural support for the third weldment 44. The lower cross brace 104 is spaced axially from the vertical beams 44A, 44B of the third weldment 44 in a direction toward the operator's compartment 22 via first and second chain anchors/primary cylinder supports 106A, 106B to define a second open area A₂ behind the lower cross brace 104, see FIG. 7. In addition to functioning as spacers to create the second open area A₂ behind the lower cross brace 104, the first and second chain anchors/primary cylinder supports 106A, 106B provide support for the cylinders 90A, 92A of the first and second primary ram/cylinder assemblies 90, 92.

The first open area A₁ behind the lower cross brace 100 extending from the second weldment 42 and the second open area A₂ behind the lower cross brace 104 extending from the third weldment 44 create enough room to allow the mast assembly 12 to be raised and then lowered onto an unattached reach assembly 14 to facilitate ease of assembly. That is, the third weldment 44 can be lowered onto the reach assembly 14 without the lower cross braces 100, 104 contacting the reach assembly 14. The open areas A₁, A₂ also allow the mast assembly 12 to be raised off of the reach assembly 14 without the lower cross braces 100, 104 contacting the reach assembly 14, thus facilitating ease of disassembly.

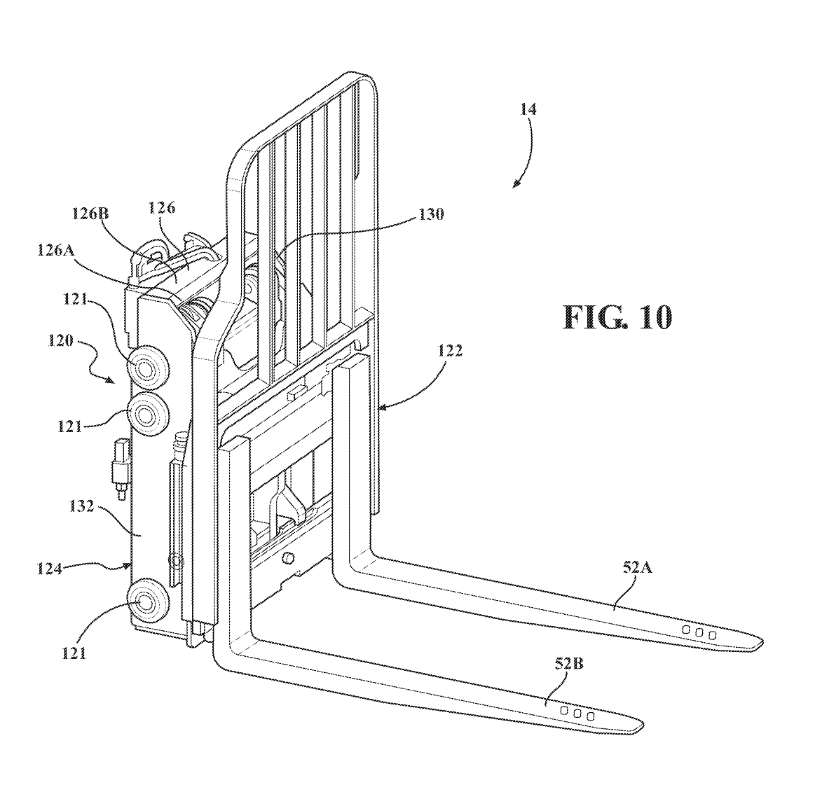

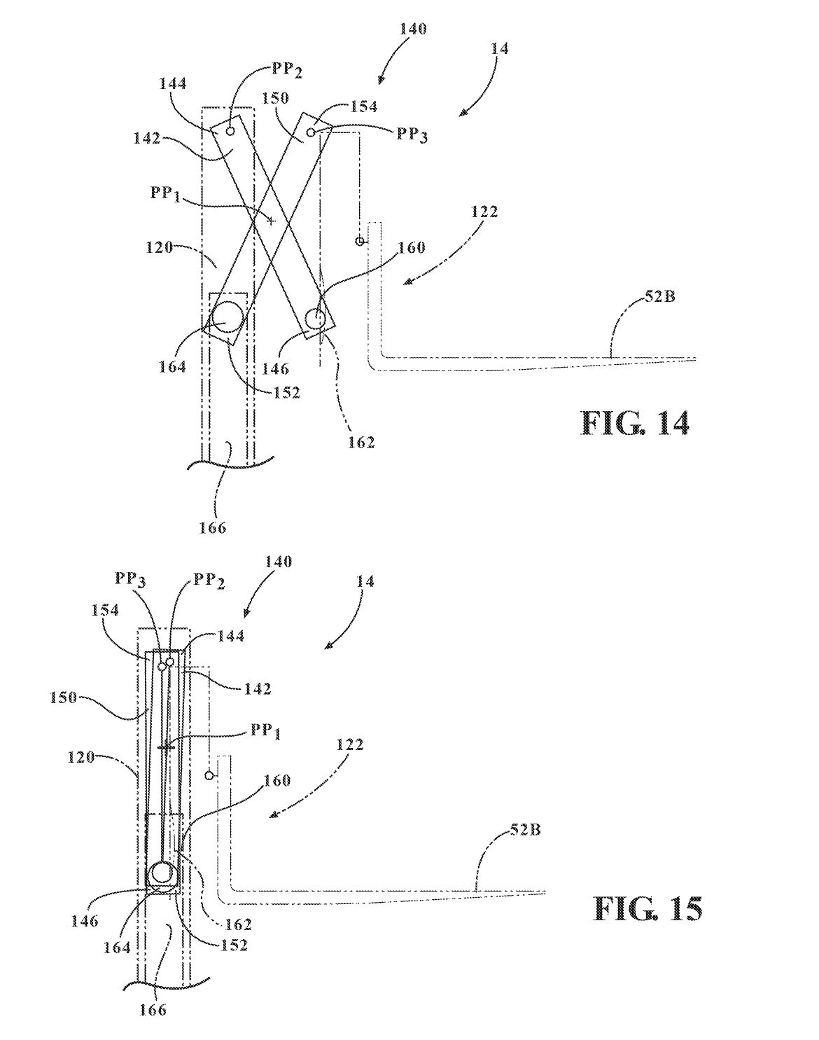

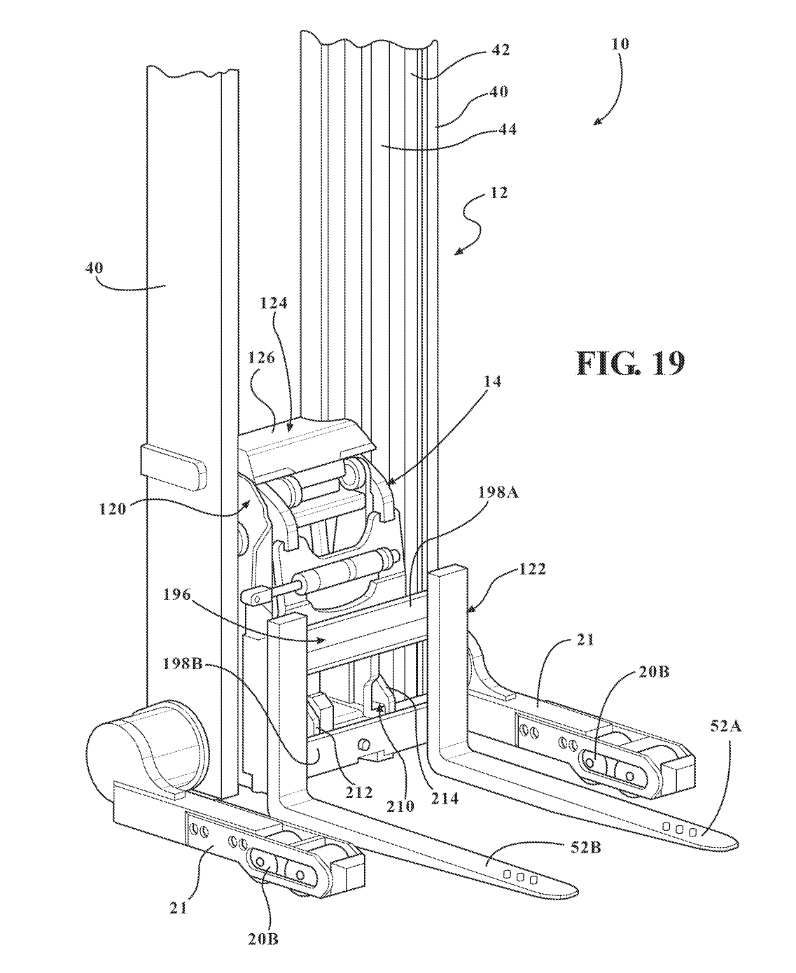

With reference to FIGS. 10-19, the reach assembly 14 according to this aspect of the invention will now be described. Referring to FIGS. 10-12 and 19, the reach assembly 14 comprises a mast carriage assembly 120 coupled for vertical movement on the mast assembly 12 (see FIG. 19), and a fork carriage assembly 122 comprising the forks 52A, 52B. Movement of the mast carriage assembly 120 relative to the mast assembly 12 is effected by the primary ram/cylinder assemblies 90, 92 as noted above, wherein a plurality of rollers 121 of the mast carriage assembly 120 travel in corresponding tracks 123 defined within the third mast weldments 44 (see FIG. 4), during the movement.

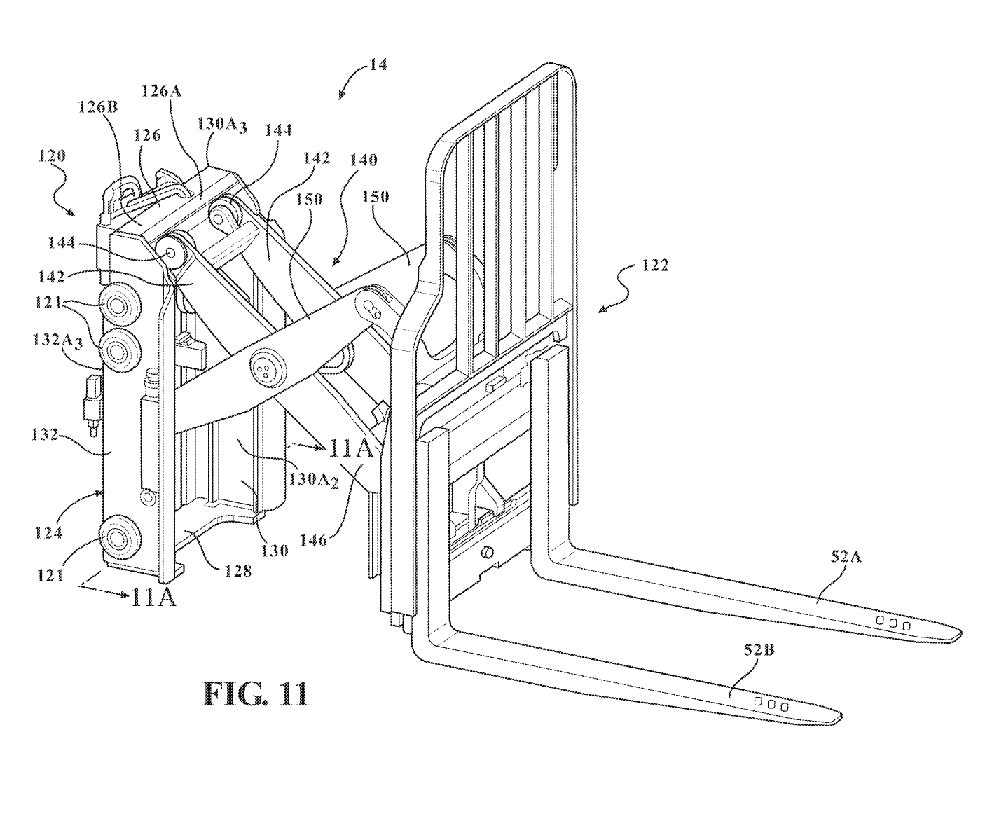

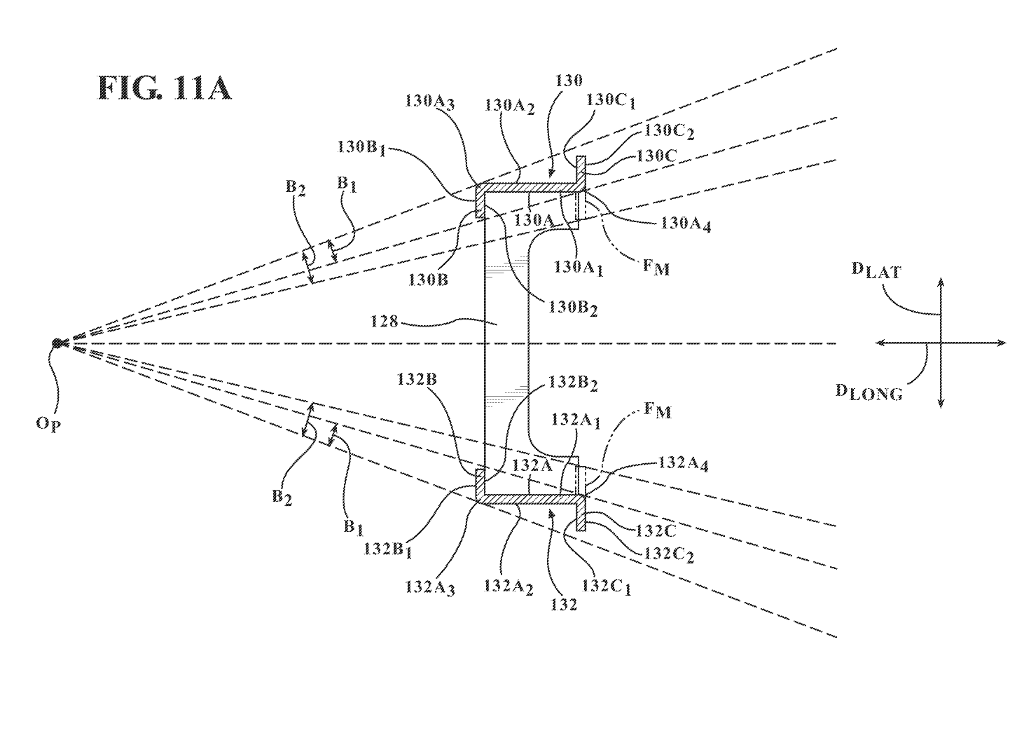

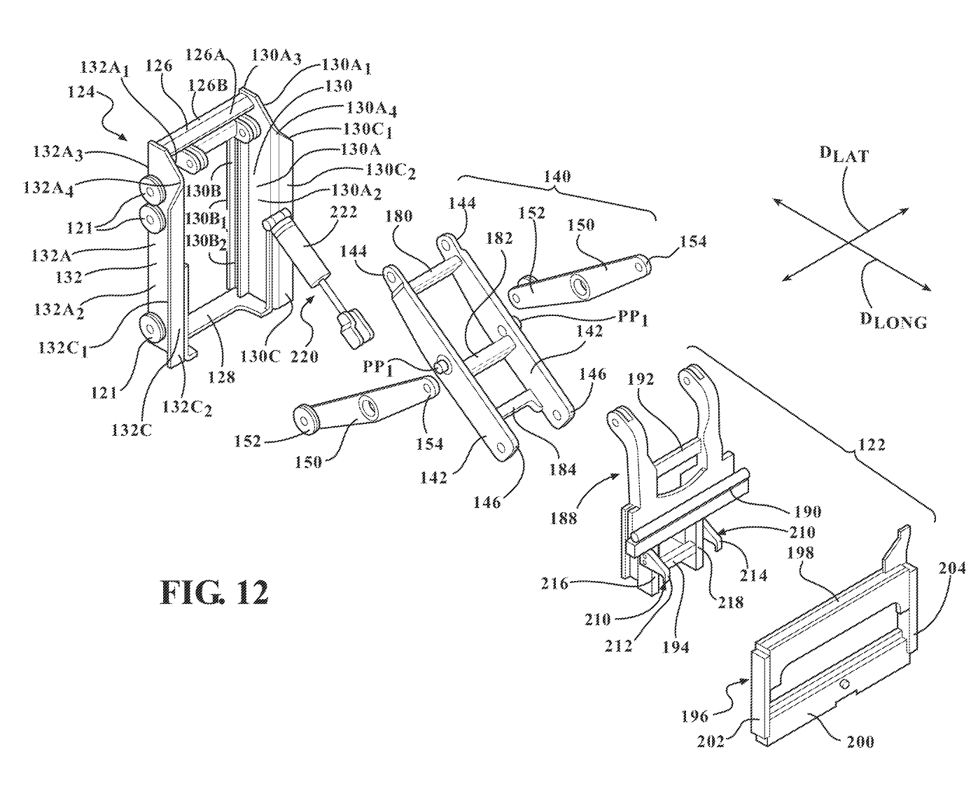

The mast carriage assembly 120 includes a rear box weldment 124 comprising an upper support plate 126, a lower support plate 128 (see FIGS. 11 and 12) vertically spaced from the upper support plate 126, and first and second side plates 130, 132 extending from the upper support plate 126 to the lower support plate 128. As shown most clearly in FIG. 12, the side plates 130, 132 each comprise an intermediate member 130A, 132A having first and second side faces 130A₁, 130A₂, 132A₁, 132A₂, that face in a lateral direction D_{LAT} of the truck 10, a rear member 130B, 132B (see FIG. 11A for the rear member 132B of the second side plate 132) extending laterally inwardly from a rear end 130A₃, 132A₃ of the respective intermediate member 130A, 132A and having first and second side faces 130B₁, 130B₂, 132B₁, 132B₂ (see FIGS. 11A and 12) that face in a longitudinal direction D_{LONG} of the truck 10, and a front member 130C, 132C extending laterally outwardly from a front end 130A₄, 132A₄ of the respective intermediate member 130A, 132A (see FIG. 12) and having first and second side faces 130C₁, 130C₂, 132C₁, 132C₂ (see FIGS. 11A and 12) that face in the longitudinal direction D_{LONG} of the truck 10. The rear ends 130A₃, 132A₃ of the respective intermediate members 130A, 132A are located proximal to the operator's compartment 22 of the truck 10 and the front ends 130A₄, 132A₄ of the respective intermediate members 130A, 132A are located distal to the operator's compartment 22 and proximal to the forks 52A, 52B.

As shown most clearly in FIG. 11A, the intermediate member 130A, 132A of each of the first and second side plates 130, 132 has a larger longitudinal dimension than lateral dimensions of the front and rear members 130B, 132B, 130C, 132C of the corresponding first and second side plates 130, 132. The front, intermediate, and rear members 130A-C, 132A-C of the side plates 130, 132 provide each of the side plates 130, 132 with a cross section having a Z-shape when viewed from above, as shown in FIG. 11A. The Z-shaped cross section of the side plates 130, 132 is believed to have the same strength as a conventional side plate having a C-shaped cross section but provides improved operator visibility past the rear box weldment 124. That is, referring to FIG. 11A, a blocked area B₁ effected by the Z-shaped side plates 130, 132, wherein the blocked area B₁ corresponds to a range of view that defines an area forward from the rear box weldment 124 that is blocked by the side plates 130, 132 for an operator O_{P} positioned in the operator's compartment 22, i.e., unless the operator O_{P} moves laterally within the operator's compartment 22, is smaller than a blocked area B₂ effected by a rear box weldment having conventional C-shaped side plates, wherein front members F_{M} of such conventional C-shaped side plates are represented in phantom lines in FIG. 11A. Further, referring to FIGS. 10-12, a front portion 126A of an upper surface 126B of the upper support plate 126 of the rear box weldment 124 is chamfered, which increases operator visibility over the top of the rear box weldment 124.

Referring now to FIGS. 10-15, the fork carriage assembly 122 is moveable longitudinally with respect to the mast carriage assembly 120. For example, the fork carriage assembly 122 is positionable in a fully retracted position as shown in FIG. 10, and a fully extended position as shown in FIG. 11. The fork carriage assembly 122 is also positionable in intermediate positions between the fully refracted and extended positions.

As shown in FIGS. 11-15, the reach assembly 14 further comprises an extension/retraction mechanism 140 for effecting horizontal movement of the fork carriage assembly 122 relative to the mast carriage assembly 120. The extension/retraction mechanism 140 according to this embodiment comprises a pair of laterally spaced apart first or inner arms 142 having first ends 144 pivotably coupled to the mast carriage assembly 120 and second ends 146 slidably coupled to the fork carriage assembly 122, and a pair of laterally spaced apart second or outer arms 150 having first ends 152 slidably coupled to the mast carriage assembly 120 and second ends 154 pivotably coupled to the fork carriage assembly 122. In the embodiment shown, the first arms 142 are located laterally inwardly from the second arms 150, see FIGS. 11 and 12.

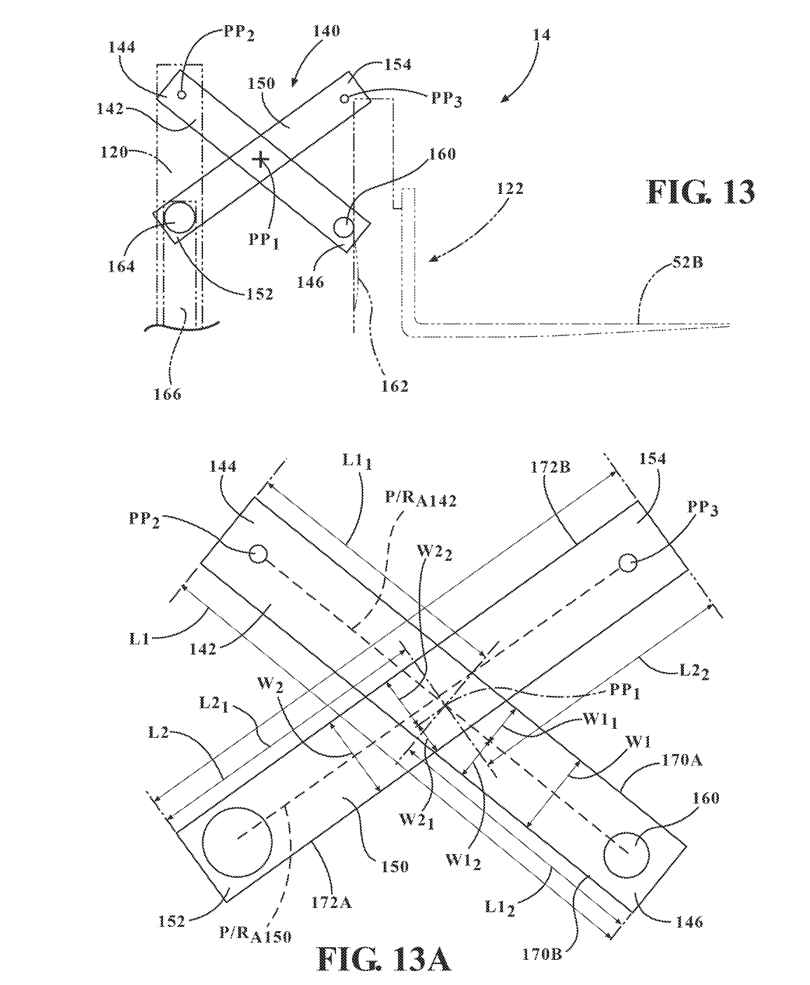

Referring to FIGS. 13-15, in the embodiment shown, the second ends 146 of the first arms 142 each comprise a first roller 160 that travels in a corresponding first track 162 formed on the fork carriage assembly 122. The first tracks 162 are preferably curved with a concave side facing away from the forks 52A, 52B so as to maintain the forks 52A, 52B relatively level, i.e., to prevent fork lift and tilt, during extension and retraction of the extension/retraction mechanism 140. The first ends 152 of the second arms 150 each comprise a second roller 164 that travels in a corresponding generally vertical second track 166 formed on the mast carriage assembly 120.

As shown in FIGS. 13-15, the second arms 150 are pivotably coupled to the first arms 142 at respective first pivot points PP₁. Referring to FIG. 13A, the first ends 144 of the first arms 142 are coupled to the mast carriage assembly 120 at second pivot points PP₂, and the second ends 154 of the second arms 150 are coupled to the fork carriage assembly 122 at third pivot points PP₃.

So as to keep spacing between the third pivot points PP₃ and the first rollers 160 at acceptable distances, i.e., the spacing between the third pivot points PP₃ and the first rollers 160 is preferably not be too small in order to maintain bearing and roller loads at desired levels, the first pivot points PP₁, i.e., where the first and second arms 142, 150 are coupled together, are offset. As seen in FIG. 13A, the first pivot points PP₁ according to this embodiment are offset along lengths L2 of the second arms 150. That is, first lengths L2₁ between the first ends 152 of the respective second arms 150 and the corresponding first pivot points PP₁ are greater than second lengths L2₂ between the second ends 154 of the respective second arms 150 and the corresponding first pivot points PP₁.

The first pivot points PP₁ in the embodiment shown are also offset from respective pivot/roller axes P/R_{A150} that extend between the locations where the first ends 152 of the respective second arms 150 are slidably coupled to the mast carriage assembly 120 and where the second ends 154 of the respective second arms 150 are pivotably coupled to the fork carriage assembly 122. In the embodiment shown, since the pivot/roller axes P/R_{A150} are located midway between forward and rear edges 172A, 172B of the second arms 150, first widths W2₁ between the forward edges 172A of the respective second arms 150 and the corresponding first pivot points PP₁ are less than second widths W2₂ between the aft edges 172B of the respective second arms 150 and the corresponding first pivot points PP₁.

While not specifically shown, the first pivot points PP₁ according to this embodiment may also be offset along lengths L1 of the first arms 142 and/or from respective pivot/roller axes P/R_{A142} that extend between the locations where the first ends 144 of the respective first arms 142 are pivotably coupled to the mast carriage assembly 120 and where the second ends 146 of the respective first arms 142 are slidably coupled to the fork carriage assembly 122. That is, first lengths L1₁ between the first ends 144 of the respective first arms 142 and the corresponding first pivot points PP₁ may be greater than second lengths L1₂ between the second ends 146 of the respective first arms 142 and the corresponding first pivot points PP₁. Also, since the pivot/roller axes P/R_{A142} are located midway between forward and rear edges 170A, 170B of the first arms 142 in the embodiment shown, first widths W1₁ between the forward edges 170A of the respective first arms 142 and the corresponding first pivot points PP₁ may be greater or less than second widths W1₂ between the aft edges 170B of the respective first arms 142 and the corresponding first pivot points PP₁.

By offsetting the first pivot points PP₁ as described above, the first and second arms 142, 150 of the reach assembly 14 are able to be shorter than arms of other reach assemblies that have an equivalent amount of reach or longitudinal extension. The shorter first and second arms 142, 150 of the reach assembly 14 reduce the overall height of the reach assembly 14 so as to improve operator visibility past the reach assembly 14.

It is noted that when the extension/retraction mechanism 140 is in its “home” or fully retracted position, the third pivot points PP₃ are located behind the second pivot points PP₂ (see FIG. 15), i.e., the third pivot points PP₃ are located closer to the operators' compartment 22 than are the second pivot points PP₂ when the extension/retraction mechanism 140 is in its “home” or fully retracted position. Thus, while the second ends 154 of the second arms 150 are located further from the operator's compartment 22 than the first ends 144 of the first arms 142 when the extension/retraction mechanism 140 is positioned in its extended position (see FIG. 13), the second ends 154 of the second arms 150 are located closer to the operator's compartment 22 of the truck 10 than the first ends 144 of the first arms 142 when the extension/retraction mechanism 140 is positioned in its fully retracted position (see FIG. 15). Such a configuration effects a visibility improvement over the top of the reach assembly 14 when in its fully retracted and lowered position.

While the first pivot points PP₁ in the illustrated embodiment are offset along the lengths L2 of the second arms 150 and also from the pivot/roller axes P/R_{A150} according to the illustrated embodiment of the present invention, each first pivot point PP₁ may be alternately configured while still allowing the arms 142, 150 to be shorter while still effecting the same amount of reach or longitudinal extension. For example, each first pivot point PP₁ may be located at least one of: closer to the first end 144 than to the second end 146 of the corresponding first arm 142; closer to the second end 146 than to the first end 144 of the corresponding first arm 142; closer to the first end 152 than to the second end 154 of the corresponding second arm 150; and closer to the second end 154 than to the first end 152 of the corresponding second arm 150. Each first pivot point PP₁ may also or alternatively be offset from the pivot/roller axes P/R_{A142} on the forward or aft edge sides of the first arms 142 and/or from the pivot/roller axes P/R_{A150} on the forward or aft edge sides of the second arms 150. Offsetting of the first pivot points PP₁ in any of these manners allows the overall lengths of the first and second arms 142, 150 to be shortened, thus reducing the overall height of the reach assembly 14 and improving operator visibility past the reach assembly 14.

Referring now to FIGS. 12, 16, and 17, the extension/retraction mechanism 140 further comprises an upper coupling member 180 extending laterally between the inner arms 142, an intermediate coupling member 182 positioned beneath the upper coupling member 180 and extending laterally between the inner arms 142, and a lower coupling member 184 positioned beneath the intermediate coupling member 182 and extending laterally between the inner arms 142. The coupling members 180, 182, 184 structurally couple the inner arms 142 together and provide structural rigidity for the extension/retraction mechanism 140.

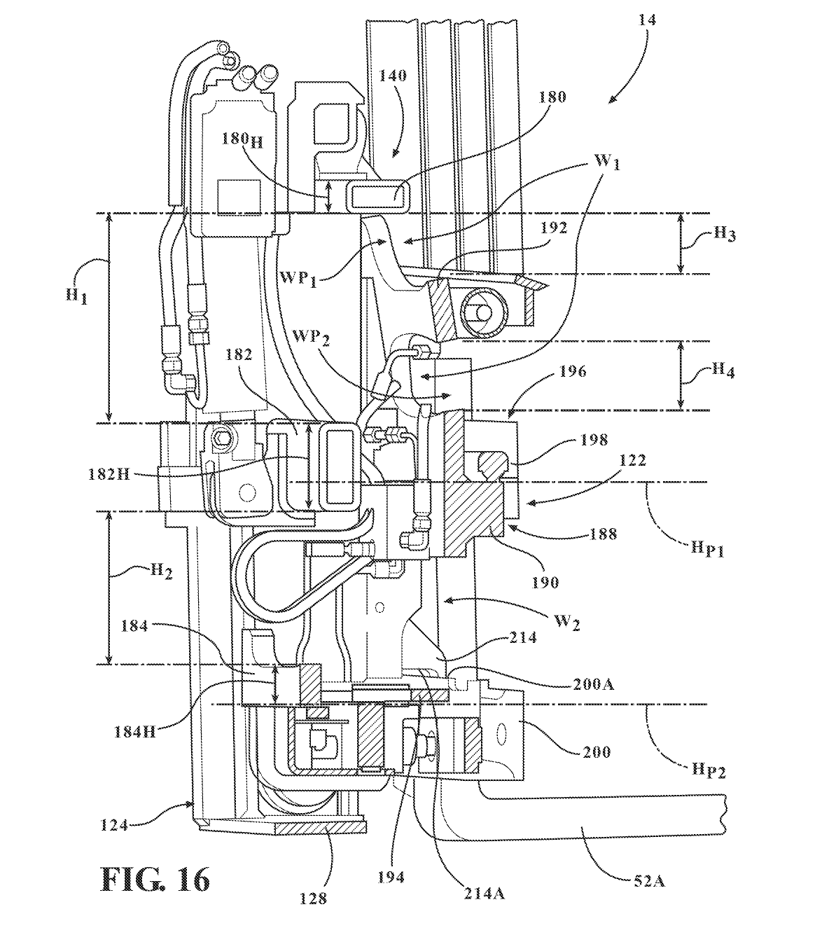

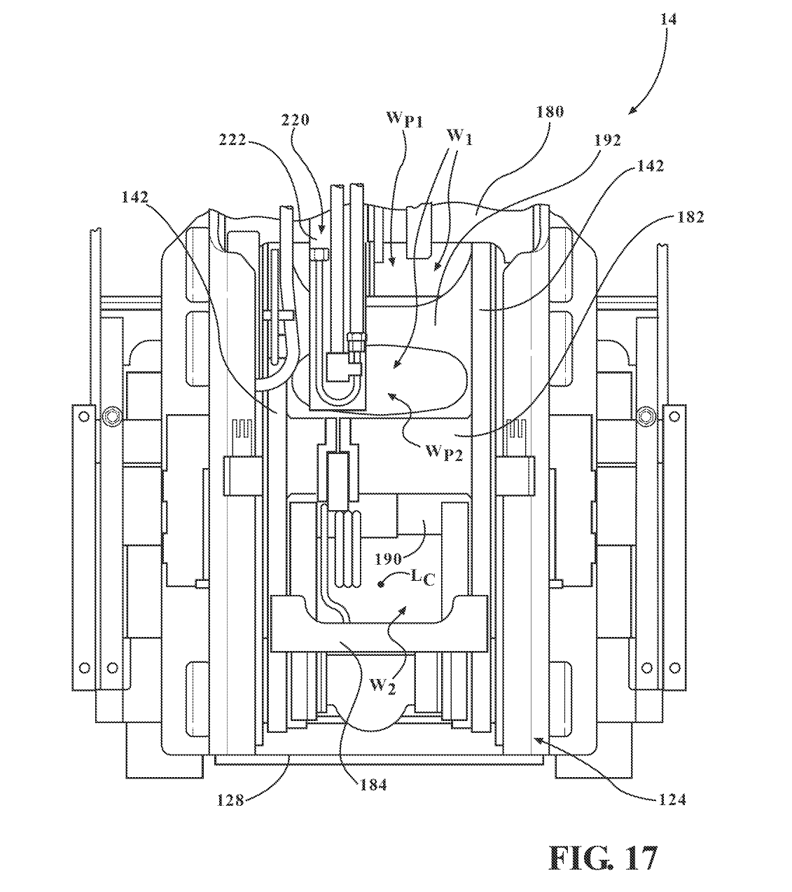

As shown in FIGS. 16 and 17, first and second vertical operator viewing windows W₁, W₂ extend longitudinally through the reach assembly 14 when the extension/retraction mechanism 140 is in a retracted position. The first operator viewing window W₁ is defined between the upper and intermediate coupling members 180, 182. The second operator viewing window W₂ is vertically spaced apart from the first operator viewing window W₁ and is defined between the intermediate and lower coupling members 182, 184. The operator viewing windows W₁, W₂ preferably have vertical dimensions, i.e., heights H₁, H₂, which are larger than respective vertical heights 180H, 182H, 184H of at least one of the coupling members 180, 182, 184, and are most preferably larger than the vertical heights 180H, 182H, 184H of each of the coupling members 180, 182, 184, as shown in FIG. 16.

As shown in FIGS. 12, 16, and 18, the fork carriage assembly 122 further comprises a Y-carriage 188 including a tilt and side shift (TSS) bar 190 used for tilt and side shift functions and upper and lower cross braces 192, 194. The upper and lower cross braces 192, 194 provide structural rigidity for the Y-carriage 188.

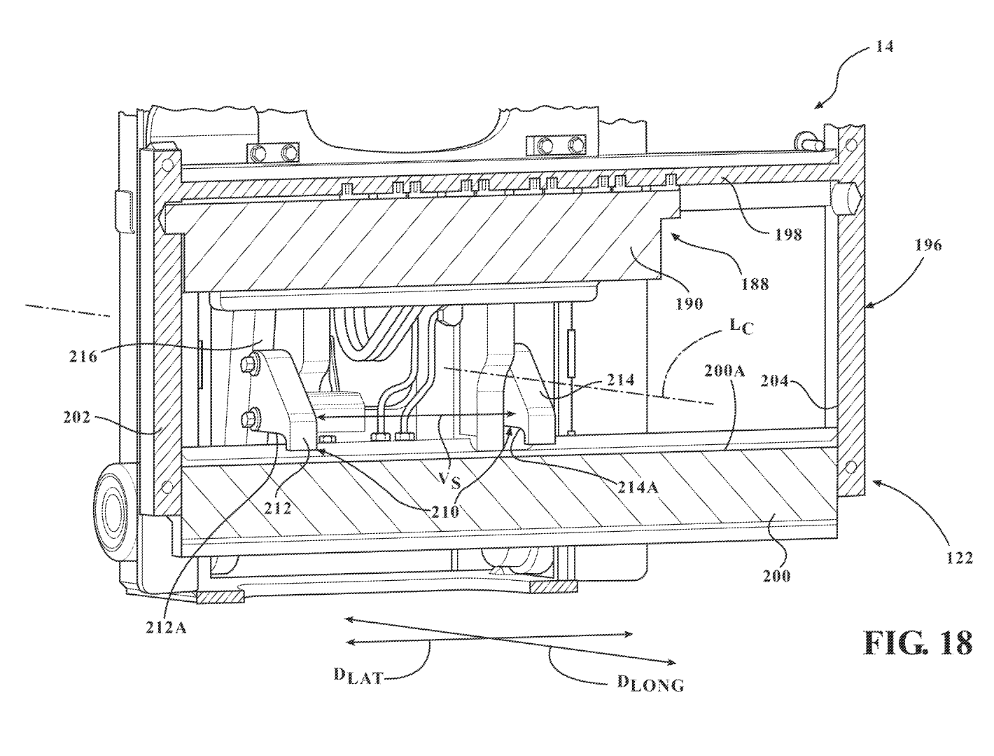

The fork carriage assembly 122 still further comprises a frame 196 including a hanger bar 198 from which the forks 52A, 52B extend (the forks 52A, 52B have been removed from FIG. 18 for clarity), a lower member 200, and laterally spaced apart side members 202, 204, see FIGS. 12 and 18. The intermediate coupling member 182, the TSS bar 190, and the hanger bar 198 of the frame 196 are all generally vertically in plane with one another when the extension/retraction mechanism 140 is in a fully retracted position, i.e., the intermediate coupling member 182, the TSS bar 190, and the hanger bar 198 of the frame 196 each intersect a common horizontal first plane H_{P1} (see FIG. 16) so as to be longitudinally stacked with one another when the extension/retraction mechanism 140 is in a fully retracted position. Hence, the heights H₁, H₂ of the respective operator viewing windows W₁, W₂ are reduced as little as possible by these respective components when the extension/retraction mechanism 140 is in a fully retracted position.

Further, the lower coupling member 184, the lower cross brace 194, and the lower member 200 of the frame 196 are all generally vertically in plane with one another when the extension/retraction mechanism 140 is in a fully retracted position, i.e., the lower coupling member 184, the lower cross brace 194, and the lower member 200 of the frame 196 each intersect a common horizontal second plane HP₂ (see FIG. 16) so as to be longitudinally stacked with one another when the when the extension/retraction mechanism 140 is in a fully retracted position. Hence, the height H₂ of the second operator viewing window W₂ is reduced as little as possible by these respective components when the extension/retraction mechanism 140 is in a fully retracted position.

As shown in FIG. 16, the upper cross brace 192 of the Y-carriage 188 is located between the upper and intermediate coupling members 180, 182 of the extension/retraction member 140 when the extension/retraction mechanism 140 is in a fully retracted position, such that the upper cross brace 192 divides the first operator viewing window W₁ into upper and lower first operator viewing window portions WP₁, WP₂. The operator viewing window portions WP₁, W₂ preferably have vertical dimensions, i.e., heights H₃, H₄, which are larger than the vertical heights 180H, 182H, 184H of at least one of the coupling members 180, 182, 184, see FIG. 16.

Referring to FIGS. 12, 18, and 19, the reach assembly 14 further comprises a tilting mechanism 210 for effecting tilting movement of the frame 196 relative to the mast carriage assembly 120. The tilting mechanism 210 comprises a pair of tilt limiters 212, 214 that are affixed to vertical members 216, 218 of the Y-carriage 188 (see FIG. 12) and extend from the vertical members 216, 218 in the longitudinal direction D_{LONG} toward the forks 52A, 52B. The tilt limiters 212, 214 limit the amount of tilting movement that the frame 196 can undergo relative to the mast carriage assembly 120. Specifically, the tilt limiters 212, 214 each have a lower abutment surface 212A, 214A for contacting an upper surface 200A of the lower member 200 of the frame 196 as the frame 196 is being tilted to define an uppermost tilt position for the frame 196.

As shown in FIG. 18, the tilt limiters 212, 214 are spaced apart from one another in the lateral direction D_{LAT} and are laterally offset with respect to a longitudinal centerline L_{C} of the truck 10, wherein a lateral distance of an operator viewing space V_{S} between the tilt limiters 212, 214 is preferably at least about 150 mm. Such spacing between the tilt limiters 212, 214 improves visibility from the operator's compartment 22 through the operator viewing space V_{S} over a configuration that includes, for example, only a single tilt limiter positioned at or near the longitudinal centerline L_{C} of the truck 10.

The reach assembly 14 also comprises a piston cylinder assembly 220 for extending and retracting the extension/retraction mechanism 140, i.e., to effect longitudinal movement of the fork carriage assembly 122 relative to the mast carriage assembly 120, see FIGS. 12 and 17 (the piston cylinder assembly 220 has been removed from the other figures for clarity). The piston cylinder assembly 220 comprises a single cylinder 222 that is laterally offset with respect to the longitudinal centerline L_{C} of the fork lift truck 10, which extends into the page as shown in FIG. 17, so as to allow improved visibility through the first and second operator viewing windows W₁, W₂.

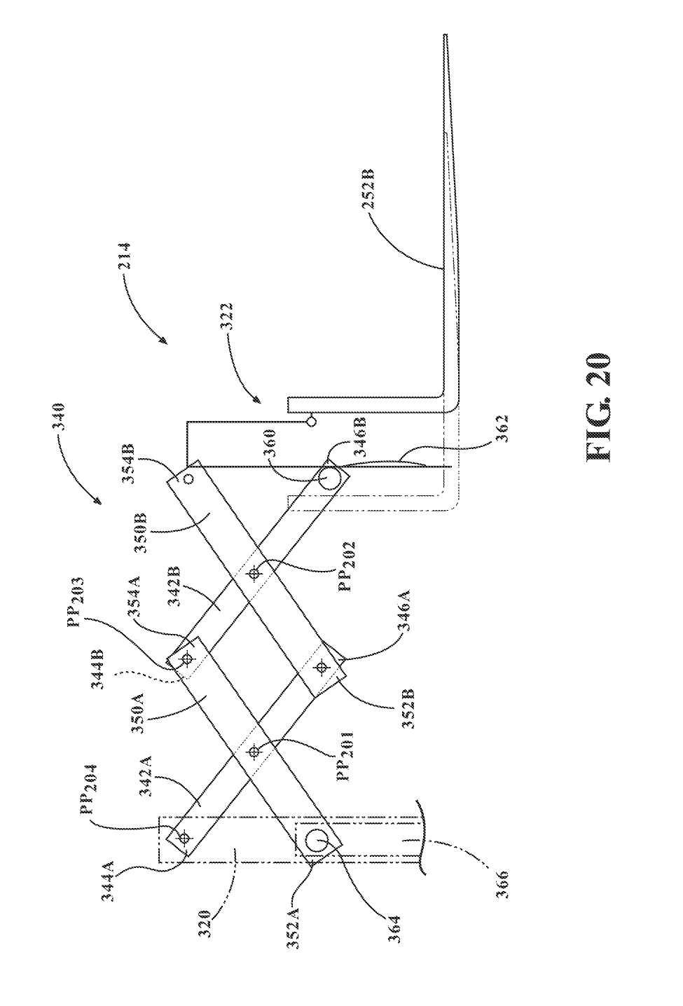

Referring now to FIG. 20, a reach assembly 214 according to another embodiment of the invention is schematically illustrated, wherein structure similar to that described above with reference to the embodiments of FIGS. 1-19 includes the same reference number increased by 200. The reach assembly 214 illustrated in FIG. 20 may be referred to as a double length reach assembly, and may be used, for example, with the truck 10 and mast assembly 12 described above.

The reach assembly 214 according to this embodiment comprises a mast carriage assembly 320 coupled for vertical movement on a mast assembly (not shown in this embodiment) of the truck, a fork carriage assembly 322 comprising a pair of forks (only one of the forks 252B is shown in this embodiment), and an extension/retraction mechanism 340 for effecting horizontal movement of the fork carriage assembly 322 relative to the mast carriage assembly 320.

The extension/retraction mechanism 340 according to this embodiment comprises a pair of laterally spaced apart rear first or inner arms 342A having first ends 344A pivotably coupled to the mast carriage assembly 320 and second ends 346A, and a pair of laterally spaced apart rear second or outer arms 350A having first ends 352A slidably coupled to the mast carriage assembly 320 and second ends 354A. The second ends 354A of the rear second arms 350A are pivotably coupled to first ends 344B of a pair of laterally spaced apart front first or inner arms 342B that also include second ends 346B that are slidably coupled to the fork carriage assembly 322. The second ends 346A of the rear first arms 342A are pivotably coupled to first ends 352B of a pair of laterally spaced apart front second or inner arms 350B that also include second ends 354B that are pivotably coupled to the fork carriage assembly 322.

According to this embodiment, the rear first arms 342A are pivotably coupled to the rear second arms 350A at respective pivot points PP₂₀₁ that may be located closer to one of the first and second ends 344A, 346A of the respective rear first arms 342A than to the other of the first and second ends 344A, 346A of the rear first arms 342A. The respective pivot points PP₂₀₁ may also or alternatively be closer to one of the first and second ends 352A, 354A of the respective rear second arms 350A than to the other of the first and second ends 352A, 354A of the rear second arms 350A. The front first arms 342B are pivotably coupled to the front second arms 350B at respective pivot points PP₂₀₂ that may be located closer to one of the first and second ends 344B, 346B of the respective front first arms 342B than to the other of the first and second ends 344B, 346B of the front first arms 342B. The respective pivot points PP₂₀₂ may also or alternatively be closer to one of the first and second ends 352B, 354B of the respective front second arms 350B than to the other of the first and second ends 352B, 354B of the front second arms 350B. Additionally or alternatively, the pivot points PP₂₀₁ and PP₂₀₂ according to this embodiment may be offset from pivot/roller axes of the respective arms 342A, 342B, 350A, 350B on the forward or rear edge sides of any of the arms 342A, 342B, 350A, 350B as described above with reference to FIGS. 13-15.

By offsetting the pivot points PP₂₀₁, PP₂₀₁ as described herein, the arms 342A, 342B, 350A, 350B of the reach assembly 214 are able to be shorter than arms of other reach assemblies that have an equivalent amount of reach or longitudinal extension. The shorter first and second arms 342A, 342B, 350A, 350B of the reach assembly 214 reduce the overall height of the reach assembly 214 so as to improve operator visibility past the reach assembly 214.

It is also noted that when the extension/retraction mechanism 340 is in its “home” or fully retracted position, pivot points PP₂₀₃ associated with the second ends 354A of the rear second arms 350A and the first ends 344B of the front first arms 342B are located behind pivot points PP₂₀₄ associated with the first ends 344A of the rear first arms 342A and the mast carriage assembly 320, i.e., the pivot points PP₂₀₃ are located closer to the operators' compartment of the truck than are the pivot points PP₂₀₄ when the extension/retraction mechanism 340 is in its “home” or fully retracted position. Thus, while the second ends 354A of the rear second arms 350A are located further from the operator's compartment of the truck than the first ends 344A of the rear first rear arms 342A when the extension/retraction mechanism 340 is positioned in its extended position, the second ends 354A of the rear second arms 350A are located closer to the operator's compartment of the truck than the first ends 344A of the rear first arms 342A when the extension/retraction mechanism 340 is positioned in its fully retracted position. Such a configuration effects a visibility improvement over the top of the reach assembly 214 when in its fully retracted and lowered position.

As shown in FIG. 20, first rollers 360 located at the second ends 346B of the front first arms 342B are slidably received in respective curved roller tracks 362 of the fork carriage assembly 322, such that when the extension/retraction mechanism 340 is extended and retracted the forks 252A, 252B of the fork carriage assembly 322 remain substantially level. Further, second rollers 364 located at the first ends 352A of the rear second arms 350A travel in corresponding generally vertical second tracks 366 formed on the mast carriage assembly 320.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A reach assembly for use on a materials handling vehicle comprising:
a mast carriage assembly coupled for vertical movement on a mast assembly of the materials handling vehicle;
a fork carriage assembly comprising a pair of forks; and
an extension/retraction mechanism for effecting horizontal movement of the fork carriage assembly relative to the mast carriage assembly, the extension/retraction mechanism comprising:
at least one first arm having a first end pivotably coupled to the mast carriage assembly and a second end slidably coupled to the fork carriage assembly; and
at least one second arm having a first end slidably coupled to the mast carriage assembly and a second end pivotably coupled to the fork carriage assembly;
wherein the at least one second arm is pivotably coupled to the at least one first arm at a pivot point that is located at least one of:
closer to the first end of the at least one first arm than to the second end of the at least one first arm;
closer to the second end of the at least one first arm than to the first end of the at least one first arm;
closer to the first end of the at least one second arm than to the second end of the at least one second arm; and
closer to the second end of the at least one second arm than to the first end of the at least one second arm.

2. The reach assembly as set out in claim 1, wherein the pivot point is located closer to one of the first and second ends of the first arm than to the other of the first and second ends of the first arm and closer to one of the first and second ends of the second arm than to the other of the first and second ends of the second arm.

3. The reach assembly as set out in claim 1, wherein the pivot point is located closer to the first end of each of the first and second arms than to the second end of each of the first and second arms.

4. The reach assembly as set out in claim 1, wherein the pivot point is located closer to the second end of each of the first and second arms than to the first end of each of the first and second arms.

5. The reach assembly as set out in claim 1, wherein the pivot point is offset with respect to an axis that extends between locations where the ends of the second arm are respectively coupled to the mast carriage assembly and the fork carriage assembly.

6. The reach assembly as set out in claim 1, wherein the second end of the first arm is slidably received in a curved roller track of the fork carriage assembly such that when the extension/retraction mechanism is extended and retracted the forks of the fork carriage assembly remain substantially level.

7. The reach assembly as set out in claim 6, wherein the first end of the second arm is slidably received in a generally vertical roller track of the mast carriage assembly.

8. The reach assembly as set out in claim 6, wherein the curved roller track of the fork carriage assembly comprises a concave side that faces away from the forks of the fork carriage assembly.

9. The reach assembly as set out in claim 1, wherein the at least one first arm comprises a pair of first laterally spaced apart arms and the at least one second arm comprises a pair of laterally spaced apart second arms.

10. The reach assembly as set out in claim 9, wherein the first arms are positioned laterally inwardly from the respective second arms.

11. The reach assembly as set out in claim 10, wherein the first arms are structurally coupled together.

12. The reach assembly as set out in claim 1, wherein the second end of the second arm is located closer to an operator's compartment of the materials handling vehicle than the first end of the first arm when the extension/retraction mechanism is positioned in a fully retracted position, the operator's compartment being located on an opposite side of the materials handling vehicle than the forks.

13. The reach assembly as set out in claim 12, wherein the second end of the second arm is located further from the operator's compartment than the first end of the first arm when the extension/retraction mechanism is positioned in an extended position.

14. A reach assembly for use on a materials handling vehicle comprising:
a mast carriage assembly coupled for vertical movement on a mast assembly of the materials handling vehicle;
a fork carriage assembly comprising a pair of forks; and
an extension/retraction mechanism for effecting horizontal movement of the fork carriage assembly relative to the mast carriage assembly, the extension/retraction mechanism comprising:
a pair of laterally spaced apart inner arms having a first ends pivotably coupled to the mast carriage assembly and second ends slidably coupled to the fork carriage assembly; and
a pair of laterally spaced apart outer arms positioned laterally outwardly from the inner arms and having first ends slidably coupled to the mast carriage assembly and second ends pivotably coupled to the fork carriage assembly;
wherein the inner arms are pivotably coupled to the outer arms at respective pivot points that are located:
closer to one of the first and second ends of the respective inner arms than to the other of the first and second ends of the inner arms; and
closer to one of the first and second ends of the respective outer arms than to the other of the first and second ends of the outer arms.

15. The reach assembly as set out in claim 14, wherein the respective pivot points are offset with respect to axes that extend between locations where the ends of the respective outer arms are respectively coupled to the mast carriage assembly and the fork carriage assembly.

16. The reach assembly as set out in claim 14, wherein the second ends of the inner arms are slidably received in respective curved roller tracks of the fork carriage assembly such that when the extension/retraction mechanism is extended and retracted the forks of the fork carriage assembly remain substantially level.

17. The reach assembly as set out in claim 16, wherein the first ends of the outer arms are slidably received in generally vertical roller tracks of the mast carriage assembly.

18. The reach assembly as set out in claim 16, wherein the curved roller tracks of the fork carriage assembly each comprise a concave side that faces away from the forks of the fork carriage assembly.

19. The reach assembly as set out in claim 14, wherein the second ends of the outer arms are located closer to an operator's compartment of the materials handling vehicle than the first ends of the inner arms when the extension/retraction mechanism is positioned in a fully retracted position, the operator's compartment being located on an opposite side of the materials handling vehicle than the forks.

20. The reach assembly as set out in claim 19, wherein the second ends of the outer arms are located further from the operator's compartment than the first ends of the inner arms when the extension/retraction mechanism is positioned in an extended position.

21. A reach assembly for use on a materials handling vehicle comprising:
a mast carriage assembly coupled for vertical movement on a mast assembly of the materials handling vehicle;
a fork carriage assembly comprising a pair of forks; and
an extension/retraction mechanism for effecting horizontal movement of the fork carriage assembly relative to the mast carriage assembly, the extension/retraction mechanism comprising:
a pair of rear first arms having first ends pivotably coupled to the mast carriage assembly and second ends;
a pair of front first arms having first ends pivotably coupled to the rear first arms and second ends slidably coupled to the fork carriage assembly;
a pair of rear second arms having first ends slidably coupled to the mast carriage assembly and second ends; and
a pair of front second arms having first ends pivotably coupled to the rear second arms and second ends pivotably coupled to the fork carriage assembly;
wherein at least one of:
the rear first arms are pivotably coupled to the rear second arms at respective pivot points that are located:
closer to one of the first and second ends of the respective rear first arms than to the other of the first and second ends of the rear first arms; and
closer to one of the first and second ends of the respective rear second arms than to the other of the first and second ends of the rear second arms; and
the front first arms are pivotably coupled to the front second arms at respective pivot points that are located:
closer to one of the first and second ends of the respective front first arms than to the other of the first and second ends of the front first arms; and
closer to one of the first and second ends of the respective front second arms than to the other of the first and second ends of the front second arms.

22. The reach assembly as set out in claim 21, wherein:
the rear first arms comprise rear inner arms;
the front first arms comprise front inner arms;
the rear second arms comprise rear outer arms; and
the front second arms comprise front outer arms.

23. The reach assembly as set out in claim 22, wherein:
the rear inner arms are pivotably coupled to the rear outer arms at respective pivot points that are located:
closer to one of the first and second ends of the respective rear inner arms than to the other of the first and second ends of the rear inner arms; and
closer to one of the first and second ends of the respective rear outer arms than to the other of the first and second ends of the rear outer arms; and
the front inner arms are pivotably coupled to the front outer arms at respective pivot points that are located:
closer to one of the first and second ends of the respective front inner arms than to the other of the first and second ends of the front inner arms; and
closer to one of the first and second ends of the respective front outer arms than to the other of the first and second ends of the front outer arms.

24. The reach assembly as set out in claim 22, wherein the second ends of the front inner arms are slidably received in respective curved roller tracks of the fork carriage assembly, such that when the extension/retraction mechanism is extended and retracted the forks of the fork carriage assembly remain substantially level.

25. The reach assembly as set out in claim 22, wherein the second ends of the rear outer arms are located closer to an operator's compartment of the materials handling vehicle than the first ends of the rear inner arms when the extension/retraction mechanism is positioned in a fully retracted position, the operator's compartment being located on an opposite side of the materials handling vehicle than the forks.

26. The reach assembly as set out in claim 25, wherein the second ends of the rear outer arms are located further from the operator's compartment than the first ends of the rear inner arms when the extension/retraction mechanism is positioned in an extended position.
